(19) United States
(12) Patent Application Publication
(10) Pub. No.: US 2026/0111125 A1
(43) Pub. Date: Apr. 23, 2026

(54) Unlocking a Data Storage Device Using a Web Application

(71) Applicant: Sandisk Technologies, Inc., Milpitas, CA (US)

(72) Inventors: Vishwas Saxena, Ghaziabad (IN); Rashi Gupta, Rampur (IN); Deepankar Kansal

(73) Assignee: Sandisk Technologies, Inc., Milpitas, CA (US)

(21) Appl. No.: 19/066,145

(22) Filed: Feb. 27, 2025

Related U.S. Application Data
(63) Continuation-in-part of application No. 18/924,819, filed on Oct. 23, 2024.

(51) Int. Cl. G06F 3/06

(52) U.S. Cl. CPC G06F 3/0622; G06F 3/061; G06F 3/0655; G06F 3/0679

(57) ABSTRACT

A data storage device (DSD) includes a storage medium and a processor. The storage medium includes a protected partition, inaccessible through mass storage device protocols, that stores program code to: emulate a webserver and to provide a first web application to a browser of the host device to configure the DSD. The storage medium includes a secured partition to store user data and an unsecured partition readable by the host device. The unsecured partition stores a second web application for the browser to unlock the DSD and to enable access to the secured partition with a mass storage device protocol.

### CROSS-REFERENCE TO RELATED APPLICATIONS

This application is a continuation-in-part of U.S. patent application Ser. No. 18/924,819, filed on Oct. 23, 2024, which is hereby incorporated by reference in their entirety.

### TECHNICAL FIELD

The present disclosure relates to communication with a data storage device and a host device. In some examples, the disclosure relates to authentication, access control, and configuration of the data storage device.

### BACKGROUND

Data encryption enables relatively secure storage on data storage devices, such as block data storage devices connectable via a Universal Serial Bus (USB) interface. However, the user experience is often disappointing because the setup of passwords, keys and the like is cumbersome and complicated for technically unskilled users. If encryption is used, the keys and passwords are too often stored insecurely. As a result, many users leave existing encryption technology effectively unused resulting in exposed confidential data.

In some data storage devices, a physical keypad is provided at the data storage device to enter passwords, keys and the like. In other data storage devices, specialized software or drivers for the data storage device must be installed on the host device to enable entry of passwords, keys and the like before secure communication with the data storage device and the host device.

To protect user data, some data storage devices automatically lock themselves after a certain period of inactivity or when disconnected from a host device (e.g., upon unplugging the device from the host computer). However, unlocking the data storage device typically requires installation of specialized software on the host device. Moreover, host devices with different operating systems usually require specific versions of the specialized software. This brings inconvenience to users, particularly when they have to access the data storage device using a temporary host device where the specialized software is unlikely to be available (e.g., a library computer or a friend's laptop). Even if installation of the specialized software is possible, it would usually require an internet connection to download and install the specialized software. Additionally, the specialized software may consume significant computer resources, such as storage space and CPU power, further limiting its usability on resource-constrained devices.

### SUMMARY

A data storage device comprising: a storage medium with at least a secured partition configured to store user data; a communication interface configured to communicate with a host device; and at least one processor. The at least one processor is configured, individually or in combination, to: communicatively couple with the host device, via a first communication channel. The at least one processor is configured to emulate a network adapter to the host device, wherein the first communication channel is enabled by an Ethernet over USB (Universal Serial Bus) protocol driver. The at least one processor is also configured to communicatively couple with the host device, via a second communication channel, wherein the second communication channel enables communication between the storage medium and the host device, and wherein the second communication channel is enabled by a USB mass storage driver. The at least one processor is further configured to receive, via the first communication channel, authentication data from the host device, wherein the authentication data is received from a web application instantiated at a browser of the host device. The at least one processor is configured to: verify that the received authentication data corresponds to a record in an authentication data set; and in response to verifying the received authentication data, selectively enable access between the host device and the secured partition via the second communication channel.

In some examples of the data storage device, the Ethernet over USB protocol driver is CDC-NCM (Communication Device Class Network Control Model).

In some examples of the data storage device, the storage medium or a further memory is configured to store the web application. The at least one processor is further configured to send to the host device, via the first communication channel, the web application or a representation of the web application.

In a further example of the data storage device, the at least one processor is further configured to emulate a server, wherein the server is configured to host the web application.

In some examples of the data storage device, the storage medium further comprises an unsecured partition configured to store the web application, and wherein the data storage device is configured send the web application from the unsecured partition to the host device via the second communication channel. In some examples of the data storage device, the web application stored in the unsecured partition is read-only and/or write protected.

In some examples of the data storage device, the communication interface includes a USB bridge, and wherein the first communication channel and the second communication channel are respective logical pipes through a USB cable between the host device and the data storage device.

In further examples, the data storage device further comprises: a first endpoint set to send and receive data transferred through the first communication channel; and a second endpoint set to send and receive data transferred through the second communication channel.

In some examples the data storage device further comprises a cryptography engine, wherein in response to selective access between the host device and the secured partition.

The cryptography engine is configured to: encrypt user data to encrypted data and in response, send the encrypted data to be stored in the secured partition; and decrypt encrypted data stored in the secured partition to user data. The communication interface is configured to receive and send user data between the data storage device and the host device, via the second communication channel.

In some examples of the data storage device, the web application comprises at least one or more of: hypertext markup language (HTML); Cascading Style Sheets (CSS); and JavaScript.

In some examples of the data storage device, the communication interface is configured to transmit and receive data, via the first communication channel, in accordance with Transmission Control Protocol (TCP) and/or User Datagram Protocol (UDP).

A method for a data storage device to communicate with a host device, the method comprising: communicatively coupling with the host device via a first communication channel, wherein the data storage device emulates a network adapter to the host device. The first communication channel is enabled by an Ethernet over USB (Universal Serial Bus) protocol driver. The method also includes communicatively coupling with the host device via a second communication channel, wherein the second communication channel enables communication between a storage medium of the data storage device and the host device, and wherein the second communication channel is enabled by a USB mass storage driver. The method also includes receiving, via the first communication channel, authentication data entered into, or via, a web application instantiated at a browser of the host device. The method further includes verifying that the received authentication data corresponds to a record in an authentication data set. In response to verifying the received authentication data, the method includes selectively enabling access between the host device and a secured partition of the storage medium of the data storage device, via the second communication channel.

In some examples of the method, the Ethernet over USB protocol driver uses CDC-NCM (Communication Device Class Network Control Model).

In some examples, in response to receiving a request to access the web application, the method further comprises sending to the host device, via the first communication channel, the web application or a representation of the web application.

In some examples of the method, communicatively coupling with the host device enables access to an unsecured partition of the storage medium of the data storage device. The unsecured partition is configured to store the web application; and the method further comprises: sending the web application from the unsecured partition to the host device, via the second communication channel.

In some examples of the method, the web application stored in the unsecured partition of the storage medium of the data storage device is read-only and/or write-protected.

In some examples of the method, the first communication channel and the second communication channel are respective logical pipes through a USB interface between the host device and the data storage device.

In some examples of the method, the secured partition of the storage medium is configured to store encrypted user data, and wherein the method further includes: receiving user data from the host device via the second communication channel and, in response, encrypting, with a cryptography engine, user data to encrypted user data; and storing the encrypted user data in the secured partition of the storage medium.

In further examples, the method includes: receiving encrypted user data stored in the secured partition of the storage medium and, in response; decrypting, with the cryptography engine, the encrypted user data to decrypted user data; and sending the decrypted user data to the host device via the second communication channel.

In some examples of the method, the web application comprises at least one or more of: hypertext markup language (HTML); Cascading Style Sheets (CSS); and JavaScript.

In some examples of the method, data transmitted via the first communication channel is transmitted in accordance with Transmission Control Protocol (TCP) and/or User Datagram Protocol (UDP).

A data storage device comprising: at least one processor; means for storing data and means for selectively enabling access between the means for storing data and a host device. The data storage device also comprises means for communicatively coupling with the host device via a first communication channel, wherein the data storage device further comprises means for emulating a network adapter to the host device, wherein the first communication channel is enabled by an Ethernet over USB (Universal Serial Bus) protocol driver. The data storage device also includes means for communicatively coupling with the host device via a second communication channel, wherein the second communication channel enables communication between the means for storing and the host device, and wherein the second communication channel is enabled by a USB mass storage driver. The data storage device also includes means for receiving, via the first communication channel, authentication data entered into, or via, a web application instantiated at a browser of the host device. The data storage device further includes means for verifying that the received authentication data corresponds to a record in an authentication data set. In response to verifying the received authentication data, the means for selectively enabling access is configured to enable access between the host device and the means for storing data, via the second communication channel.

A data storage device, comprising: a storage medium comprising: a protected partition inaccessible through a mass storage device protocol, wherein the protected partition stores program code, when executed, to emulate at least a webserver configured to provide a first web application to a browser of a host device to configure the data storage device; a secured partition configured to store user data under the mass storage device protocol, and an unsecured partition readable by the host device, wherein the unsecured partition stores at least a second web application, wherein the second web application is different from the first web application and is executable through the browser of the host device to unlock the data storage device; a communication interface configured to communicate with the host device; and at least one processor configured, individually or in combination, to: communicatively couple with the host device, via at least one control communication channel, wherein the at least one processor is configured to emulate a network adapter to the host device, wherein the at least one control communication channel is enabled by an Ethernet over USB protocol driver, wherein the second web application is configured to specify an IP address associated with the data storage device for unlocking the data storage device via the at least one control communication channel; receive, via the at least one control communication channel, authentication data to unlock the data storage device, wherein the authentication data is received from the second web application instantiated at the browser of the host device; verify that the received authentication data corresponds to a record in an authentication data set configured by the first web application; and in response to verifying the received authentication data, unlock the data storage device to enable access between the host device and the secured partition via a data communication channel, wherein the data communication channel is enabled by a USB mass storage driver.

In some embodiments, specifying the IP address associated with the data storage device by the second web application comprises: retrieving, by the second web application, a predefined IP address corresponding to the webserver of the data storage device, wherein the predefined IP address is stored in the second web application or stored in a second web application data structure associated with the second web application, wherein the second web application data structure is stored in the secured partition.

In some embodiments, retrieving the predefined IP address corresponding to the webserver of the data storage device comprises: receiving, by a TCP/IP (Transmission Control Protocol/Internet Protocol) stack of the host device, the predefined IP address from the second web application.

In some embodiments, the first web application is configured to configure the data storage device via the at least one control communication channel.

In some embodiments, the first web application is configured to configure the data storage device via a first control communication channel of the at least one control communication channel, and wherein the data storage device is configured to receive the authentication data to unlock the data storage device via a second control communication channel of the at least one control communication channel.

In some embodiments, the first control communication channel is different from the second control communication channel.

In some embodiments, the first control communication channel is the same as the second control communication channel.

In some embodiments, the at least one processor is further configured to receive, via the at least one control communication channel, an unlock request from the host device using the second web application, wherein in response to receiving the unlock request, the second web application initiates a first interface in the browser of the host device, wherein the first interface is configured to receive the authentication data to unlock the data storage device.

In some embodiments, the second web application is configured to automatically initiate the first interface in the browser of the host device in response to the at least one control communication channel being established.

In some embodiments, the Ethernet over USB protocol driver is a CDC-NCM driver, wherein the unlock request from the host device and the authentication data are received from the CDC-NCM driver over the at least one control communication channel.

In some embodiments, the first web application configuring the data storage device comprises any one or more of: sending the first web application 40 from the protected partition to the host device, wherein the host device instantiates the first web application on the browser of the host device; configuring data related to access control including storing the authentication data set in the protected partition; encrypting the data related to access control; and/or initializing the second web application including any one or more of: configuring any one or more of: the first interface, a second interface of the second web application configured to receive the unlock request from the host device, and/or a third interface of the second web application configured to present whether the data storage device is unlocked or not; linking an authentication module of the at least one processor of the data storage device to the second web application; and/or enabling encryption to the unlock request and/or the authentication data.

In some embodiments, the second web application stored in the secured partition is read-only and/or write protected.

In some embodiments, the communication interface includes a USB bridge, and wherein the at least one control communication channel and the data communication channel are respective logical pipes through a USB interface between the host device and the data storage device.

In some embodiments, the first web application and/or the second web application comprise at least one or more of: Hypertext Markup Language; Cascading Style Sheets; and JavaScript.

A method for unlocking a data storage device using a host device, wherein the data storage device comprises a storage medium comprising: a protected partition inaccessible through a mass storage device protocol, wherein the protected partition stores program code that, when executed, to emulate at least a webserver configured to provide a first web application to a browser of a host device to configure the data storage device; and a secured partition configured to store user data under the mass storage device protocol, wherein the secured partition stores at least a second web application, wherein the second web application is different from the first web application and is executable through the browser of the host device to unlock the data storage device; wherein the data storage device further comprises a communication interface configured to communicate with a host device and at least one processor; the method comprising: communicatively coupling with the host device, via at least one control communication channel, wherein the at least one processor is configured to emulate a network adapter to the host device, wherein the at least one control communication channel is enabled by an Ethernet over USB protocol driver, wherein the second web application is configured to specify an IP address associated with the data storage device for unlocking the data storage device via the at least one control communication channel; receiving, via the at least one control communication channel, authentication data to unlock the data storage device, wherein the authentication data is received from the second web application instantiated at the browser of the host device; verifying that the received authentication data corresponds to a record in an authentication data set configured by the first web application; and in response to verifying the received authentication data, unlocking the data storage device to enable access between the host device and the secured partition via a data communication channel, wherein the data communication channel is enabled by a USB mass storage driver.

In some embodiments, specifying the IP address associated with the data storage device by the second web application comprises retrieving a predefined IP address corresponding to the webserver of the data storage device, wherein the predefined IP address is stored in the second web application.

In some embodiments, retrieving the predefined IP address corresponding to the webserver of the data storage device comprises receiving, by a TCP/IP stack of the host device, the predefined IP address from the second web application.

In some embodiments, the first web application is configured to configure the data storage device via a first control communication channel of the at least one control communication channel, wherein the data storage device is configured to receive the authentication data to unlock the data storage device via a second control communication channel of the at least one control communication channel, and wherein the first control communication channel is different from the second control communication channel.

In some embodiments, the method further comprises configuring the data storage device, the method comprising: sending the first web application from the protected partition to the host device, wherein the host device instantiates the first web application on the browser of the host device; receiving, from the host device, configuration data related to access control, including data related to the authentication data set; storing, via the first web application, at least one record of the configuration data related to access control in the protected partition; encrypting the data related to access control; and/or initializing the second web application including any one or more of: generating any one or more of: the first interface, a second interface of the second web application configured to receive the unlock request from the host device, and/or a third interface of the second web application to present whether the data storage device is unlocked or not; linking an authentication module of the at least one processor of the data storage device to the second web application; and/or enabling encryption to the unlock request and/or the authentication data.

A data storage device comprising: means for storing data, the data including program code, when executed, to emulate at least a webserver configured to provide a first web application to a browser of a host device to configure the data storage device, a second web application, wherein the second web application is different from the first web application and is executable the browser of the host device to unlock the data storage device; means for communicatively coupling with the host device, via at least one control communication channel, wherein the at least one processor is configured to emulate a network adapter to the host device, wherein the at least one control communication channel is enabled by an Ethernet over USB protocol driver, wherein the second web application is configured to specify an IP address associated with the data storage device for unlocking the data storage device via the at least one control communication channel, means for receive, via the at least one control communication channel, authentication data to unlock the data storage device, wherein the authentication data is received from the second web application instantiated at the browser of the host device; means for verifying that the received authentication data corresponds to a record in an authentication data set configured by the first web application; and means for unlocking the data storage device to enable access between the host device and the secured partition via a data communication channel, wherein the data communication channel is enabled by a USB mass storage driver.

### BRIEF DESCRIPTION OF DRAWINGS

FIG. 1 illustrates a schematic diagram of a data storage device and host device in communication via a first communication channel and a second communication channel with respective drivers;

FIG. 2 illustrates another schematic diagram of the data storage device and host device and components therein;

FIG. 3 illustrates a flow diagram of a method for the data storage device to communicate with the host device;

FIG. 4 is a representation of the host device connected to a network adapter and a mass storage device;

FIG. 5 illustrates a user interface of a host device showing connected networks including to an emulated network via the network adapter;

FIG. 6 illustrates the user interface of the host device showing a connected mass storage device;

FIG. 7 illustrates a representation of a web application at a browser of the host device including a graphical user interface to unlock the data storage device;

FIG. 8(a) and 8(b) illustrate a representation of the web application at the browser including a graphical user interface to lock the data storage device;

FIG. 9(a) and 9(b) illustrate a representation of the web application at the browser including a graphical user interface to set authentication data in the form of a password;

FIG. 10(a) and 10(b) illustrate a representation of the web application at the browser including a graphical user interface to reset the authentication data;

FIG. 11(a) and 11(b) illustrate a representation of the web application at the browser including a graphical user interface to remove authentication data;

FIG. 12 illustrates a flow diagram of the data storage device operating to encrypt data received from the host device and to decrypt encrypted data to be sent to the host device;

FIG. 13 illustrates another schematic diagram of the data storage device and host device and components therein;

FIG. 14 illustrates a representation of the host device connected to network adapters and a data storage device that can be unlocked by the host device;

FIG. 15 illustrates a representation of a schematic diagram of the data storage device and host device in communication via at least one control communication channel and a data communication channel for unlocking the data storage device; and

FIG. 16 illustrates a flow diagram of unlocking the data storage device using at least one web application.

### DESCRIPTION OF EMBODIMENTS

### Overview

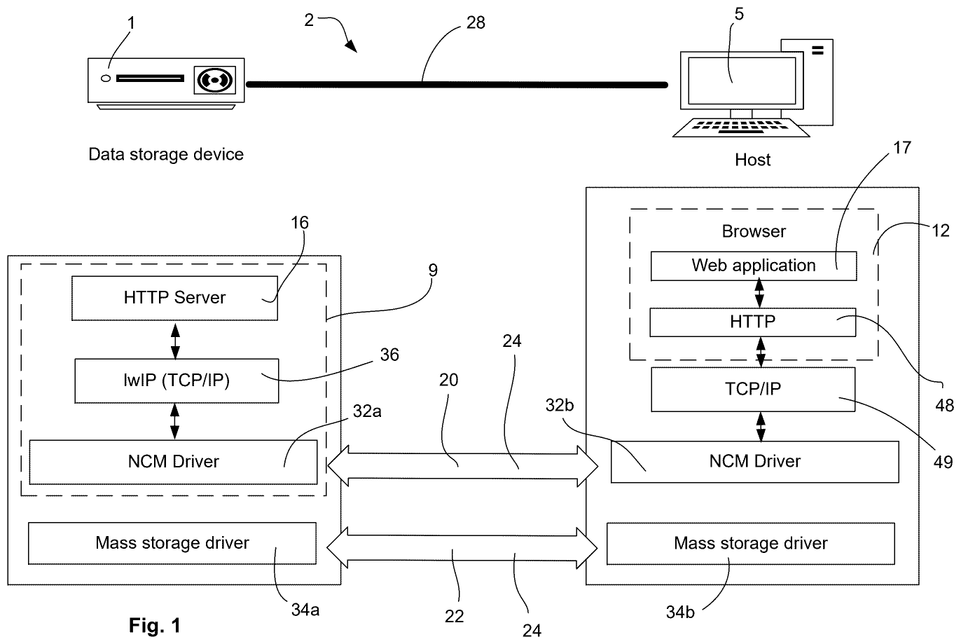

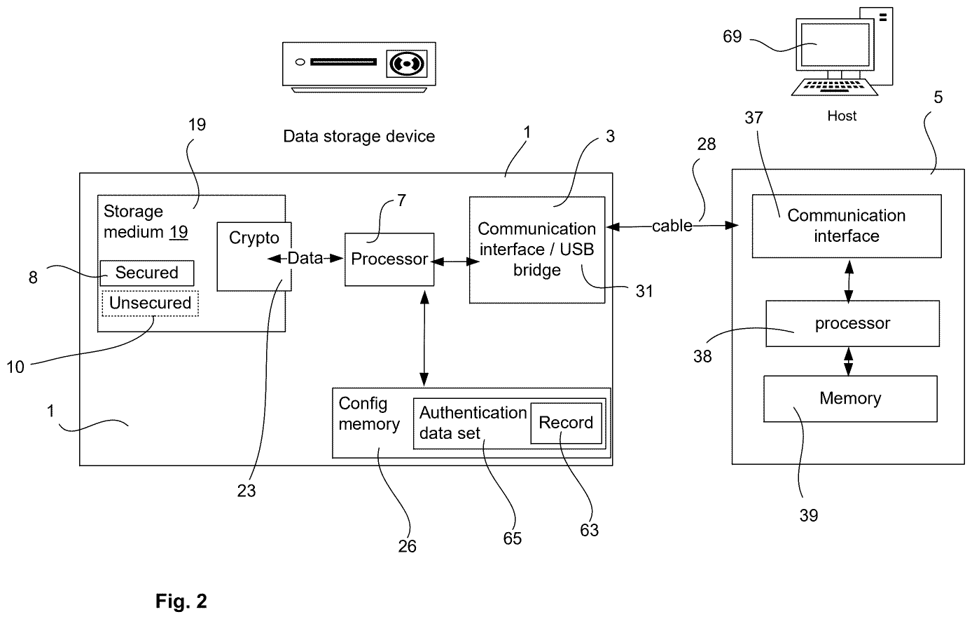

FIGS. 1 and 2 illustrate an example of a data storage device 1 configured to be communicatively coupled with a host device 5. FIG. 1 illustrates a simplified schematic of data flow and technology topology, and FIG. 2 illustrates a simplified schematic of components of the device. The data storage device 1 includes a storage medium 19 with at least a secured partition 8 that is configured to store user data. The data storage device also includes a communication interface 3 configured to communicate with the host device 5, which in some examples includes a universal serial bus (USB) bridge configured to transmit and receive data via a USB cable 28 to the host device 5. The data storage device also comprises at least one processor 7 configured to execute program code stored within a memory 26 to issue commands for controlling the operation of the data storage device 1.

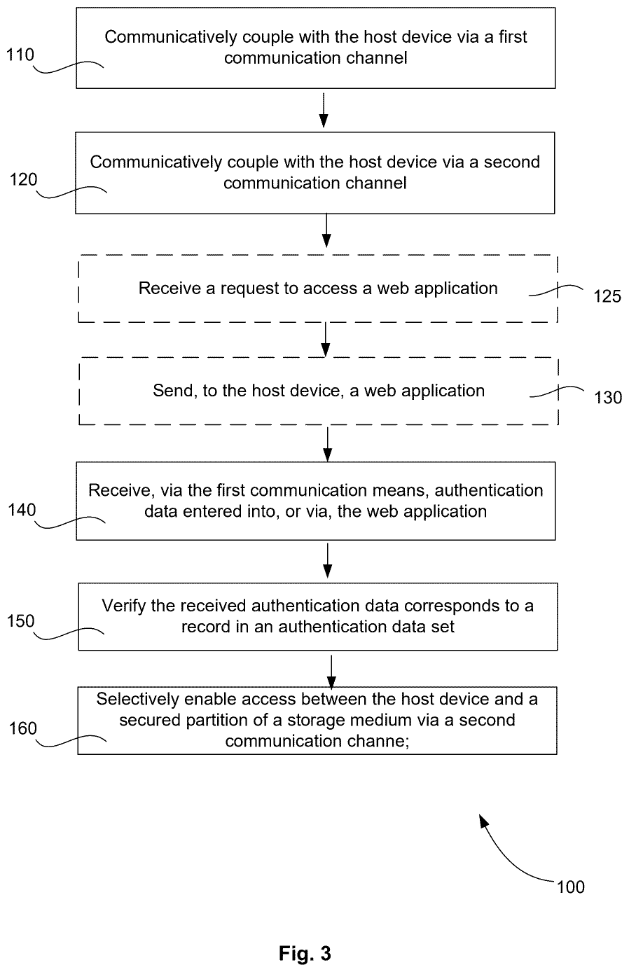

The at least one processor 7 is configured, individually or in combination to perform steps in a method 100, as illustrated in FIG. 3, to enable communication of user data between the storage medium 19 and the host device 5. This includes communicatively coupling 110 with the host device 5 via a first communication channel 20, wherein the at least once processor is configured to emulate a network adapter 9 to the host device 5. The first communication channel is enabled by an Ethernet over USB protocol driver 32a, 32b. Thus from the host device perspective, the first communication channel 20 provides a connection to a (emulated) network. This first communication channel 20 may be configured to transmit and receive security commands discussed below.

The at least one processor 7 is also configured to communicatively couple 120 with the host device 5 via a second communication channel 22, wherein the second communication channel 22 enables communication between the storage medium 19 and the host device. The second communication channel 22 is enabled by a USB mass storage driver 34a, 34b). Thus from the host device perspective, the second communication channel 22 provides a connection to a mass storage device. This second communication channel 22 may be configured to transmit and receive user data.

Thus in some examples, the host device 5 communicating with the communication interface 3 have respective endpoints for two USB devices, namely the (emulated) network adapter and a mass storage device.

The data storage device 1 may be configured to enable selective access to the storage medium 19, such as with verification of authentication data in an unlocking process. This can include the at least one processor 7 receiving 140, via the first communication channel 20, authentication data 61 from the host device 5. The authentication data is be received from a web application 17 instantiated at a browser 12 of the host device 5. Notably, the authentication data 61, which may be part of a security command, is transmitted via the first communication channel 20 enabled by the emulated network adapter.

The at least one processor is configured to verify 150 that the received authentication data 61 corresponds to a record 63 in an authentication data set 65. In response to verifying the received authentication data, the at least one processor selectively enables access between the host device 5 and a secured partition 8 of the storage medium 19 via the second communication channel 22. In some examples, this can include enabling a cryptography engine 23 to encrypt and decrypt user data stored in the secured partition 8 of the storage medium 19.

In some examples, the Ethernet over USB protocol driver 32a, 32b, is CDC-NCM (Communication Device Class Network Control Model). This can be advantageous in that CDC-NCM drivers are provided on a wide variety of operating systems in contemporary host devices 5. This can include Windows and MacOS for laptop and desktop computers, as well as operating systems of mobile devices including some tablet devices and smartphones. Therefore examples of the data storage device 1 can be used with a host device 5 without requiring special drivers to be installed on the host device 5.

Furthermore, the web application 17 is a web-based application that is instantiated in a web browser 12 of the host device 5. This can include any web browser 12 that can run web applications 10. For example, web applications using hypertext markup language (HTML). Advantageously, many computers and mobile communication devices are configured with a web browser 12 and therefore running a web application 17 can be more convenient than requiring users to install a native application to the host device 5. Thus the data storage device 1 can be used with a wide variety of host devices 5 and operating systems without having to install specialised drivers or software. This can be particularly useful in environments where technical, communication, security, organizational policy, or other reasons prevent or impede a user of a host device 5 from installing device drivers or software on the host device 5.

The components of an example of a data storage device will now be described in detail. It is to be appreciated that alternative examples may include more, or less, features.

### Hardware

### Data Storage Device

The data storage device 1, in general, is configured to be used with a host device 5 to store user data. In some examples, the data storage device 1 is a device external to the host device 5 and can be configured to be a portable device. In particular, the data storage device 1 can be configured for use with the host device 5 by connecting a cable 28 between respective communication interfaces 3, 37. When not in use, the cable 28 can be disconnected and the data storage device 1 may be moved and transported, and in some examples, used with another host device.

The data storage device 1 is configured with security features to control access to user data stored in the data storage device 1. In some examples, the data storage device is a self-encrypting drive (SED).

### Communication Interface 3 and Communication Channels

The communication interface 3 enables communication between the data storage device 1 and the host device 5. In this example, one function is to provide a wire-based data port between the host device 5 and components of the data storage device 1. In a preferred example, this includes a USB (universal serial bus) bridge 31 to enumerate with the host device 5.

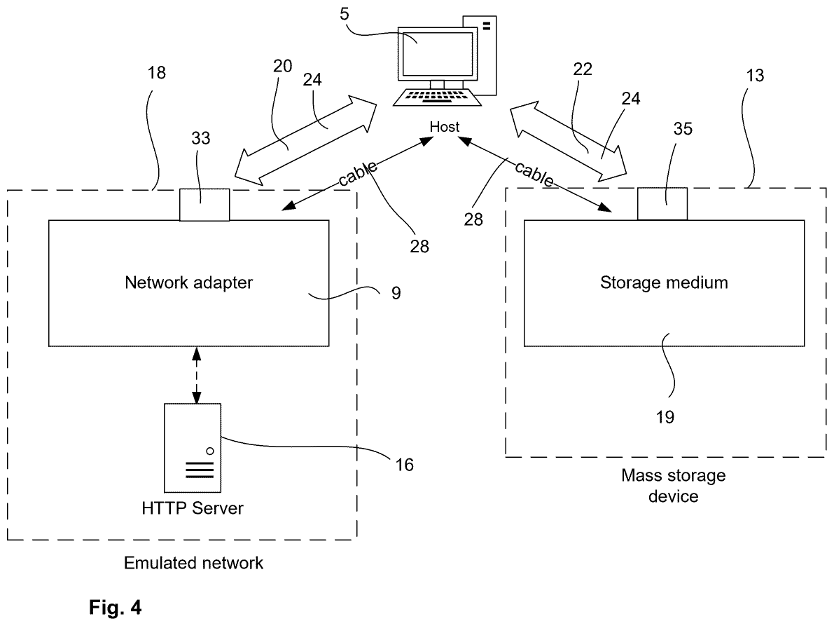

In use, the data storage device 1 can appear, from the perspective of the host device 5, as two different downstream peripheral devices as illustrated in FIG. 4. That is, the communication interface 3 can function as a USB hub. One peripheral device is as a mass data storage device 13, whereby the host uses the storage medium 19 to store, read, and write, user content data. The other peripheral device is where the at least one processor 7 emulates a network adapter 9 and an emulated HTTP server 16 in an emulated network 18.

Thus the first communication channel 20 and second communication channel 22 are respective logical pipes, and data from the two channels may pass through a common physical cable set 28 (such as a USB cable) between the host device 5 and the data storage device 1.

Thus the data storage device 1 is configured to have a first endpoint set 33 to send and receive data transferred through the first communication channel 20 to the network adapter 9. The data sent through the first communication channel can include security commands, or setup/configuration commands, to the data storage device.

Furthermore, a second endpoint set 35 is configured to send and receive data transferred through the second communication channel 22 to the mass storage device 13/storage medium 19. The second communication channel 22 is used for sending and receiving user data to the storage medium 19 of the data storage device 1 (i.e. the mass storage device 13 function).

### Storage Medium 19

One function of the data storage device 1 is to register with the host device 5 as a mass data storage device providing the functionality to the operating system of the host device 5 of a block data storage device. Data storage device 1 includes a non-transitory storage medium 19 to store user content data. In some examples, this includes unencrypted user content data. In other examples, the storage medium 19 stores encrypted user content data. In some examples, the data storage device is a self-encrypting drive where data is encrypted by a cryptography engine 22 discussed in a separate section below.

The user content data is the data that a user would typically want to store on a data storage device, such as files including image files, documents, video files, etc. The storage medium may be a solid state drive (SSD), hard disk drive (HDD) with a rotating magnetic disk or other non-volatile storage media. Further, the storage medium may be a block data storage device, which means that the user content data is written in blocks to the storage medium 19 and read in blocks from the storage medium 19.

The storage medium 19 includes a secured partition 8 to store user data that is selectively accessible when the data storage device 1 is unlocked. That is, the secured partition 8 is only accessible when authentication data has been verified.

In some examples the storage medium 19 includes only a single secured partition 8 (i.e. the single secured partition 8 exclusively occupies all the storage medium 19). In other examples, the storage medium 19 may be divided into multiple secured partitions 8 that can enable multiple users to have their own respective secured partitions 8 in the same data storage device 1.

In further examples, the storage medium 19 may have a further unsecured partition 10. By unsecured, this means that a host device 5 can read data from the unsecured partition without presenting verified authentication data. In some examples, this is useful for storing data that is freely readable. This can include storing a copy of the web application 17. Thus in some examples, the further unsecured partition 10 may, from the perspective of the host device 5, appear as a mass storage device that is accessible after the cable 28 is connected to the respective communication interfaces 3. This can enable the host device 5 to request a copy of the web application from the unsecured partition 10. Subsequently, the web application is sent from the unsecured partition 10 to the host device 5, via the second communication channel 22. The web application 17 can then run on a browser 12 of the host device 5.

In examples where the web application 17 is stored in the unsecured partition 10, it may be advantageous for the web application 17 to be write protected. This can include specifically write protecting the web application 17. In further examples, this can include write-protecting (or otherwise specifying read-only) for the unsecured partition 10. This can prevent the web application from being inadvertently, or deliberately, deleted or altered. This advantageously enables the web application 17 to be easily available to a host device 5.

In one alternative, the web application 17 is sent 130 to the host device 5 via the first communication channel 20. That is, sent via the emulated network adapter 9. In such examples, the web application 17 may be stored in the storage medium and the at least one processor 7 is configured to send the web application 17 from the storage medium 19 to the host device 5.

### Cryptography Engine

In one example, storage medium 19 comprises a cryptography engine 22 in the form of a dedicated and/or programmable integrated circuit that encrypts data to be stored on storage medium 19 and decrypts data to be read from storage medium 19

The cryptography engine 22 is connected between the communication interface 3/processor 7 and the storage medium 19 and is configured to use a cryptographic key to encrypt 152 user content data into encrypted data to be stored in the secured partition 8 of the storage medium 19. The cryptography engine 22 may also decrypt the encrypted user content data stored in the secured partition 8 of the storage medium 19 into user data to be sent to the host device 5. The cryptography engine 22 may be enabled to perform these functions in response to the at least one processor 7 enabling selective access to the host device 5. The user content data is sent and received to the host device 5, via the cryptography engine 22 and the second communication channel 22.

The at least one processor 7 can function as an access controller and provides, at least in part, the cryptographic key to the cryptography engine 22. For example the at least one processor 7 provide the key to the cryptography engine 22.

The interface between the at least one processor 7 and the communication interface may be an integrated circuit bus which is useful in case this bus is implemented in existing chips. However, it is possible to use many other communication architectures including bus, point-to-point, serial, parallel, memory based and other architectures. The separation of functionality in dedicated chips as illustrated in FIG. 1 is only an example of one implementation. It is possible to combine the functionalities or split the functionalities further. For example, the communication interface may be integrated with the at least one processor 7 into a single chip with a single core. In other cases, the communication interface 3 and the at least one processor 7 can be integrated with the cryptography engine 22 into a single dedicated chip with a single core. In other examples, the chips may have multiple cores.

### Processor

The at least one processor 7 is associated with configuration memory 26 storing software to implement the method described herein. A processor may comprise one or more of microprocessors, microcontrollers, controlling circuitry, or a combination thereof. The one or more processors are, in combination or individually, configured to execute program code stored within the memory 26 to issue commands for controlling the operation of the data storage device 1.

One function of the at least one processor 7 is to emulate a network adapter 9 and server (such as HTTP server 16), to enable authentication data (and other security or configuration commands) to be received via the first communication channel 20. In further examples, this includes additional communication through the first communication channel 20 to the web application 17 instantiated at the browser 12 at the host device 5.

This can include the processor 7 performing additional communication 20 with the host device 5 that is associated with authentication, including authenticating as well as enrolling and configuration for future authentication. Additional communication can also include access control, and other configuration of the data storage device. These will be described in further detail below with reference to example methods.

In some examples, the at least one processor 7 is also involved with access control, including selectively enabling access between the secured partition 8 of the storage medium 19 and the host device 5. In one example, this can include enabling access by sending a cryptographic key to the cryptography engine 22 when authentication and/or authorization requirements are satisfied. This may be responsive to, in some examples, receiving valid authentication data from the host devices through the web application.

In one example, the at least one processor 7 may include a reduced instruction set computer (RISC). In one example, the at least one processor 7 is a Cortex M0 microcontroller from ARM Limited.

### Configuration Memory

Configuration memory 26 stores data related to configuration of the data storage device 1. This may include data related to access control (including authentication data set, cryptographic keys), and other configuration parameters. This may include data related to the web application 17, the HTTP server 16, and the emulated network adapter 9.

Firmware associated with the at least one processor 7 may be stored in the configuration memory 26 or other non-volatile memory. In some examples, the web application 17, or part of the web application, may be stored in the configuration memory 26 (that is separate to the storage medium 19). This may include server-side scripts of the web-application run on the at least one processor 7 to emulate the server 16. In other examples, this may also include client-side scripts that are sent 130 to the host device 5, by the at least one processor 7 via the first communication channel 20.

It is to be appreciated that in some examples, part of the storage medium 19 may be used to store data as the configuration memory.

### Authentication Data Set

The configuration memory may also include an authentication data set. This may include user identifier(s) and respective password(s) of authorized user(s). The authentication data set 65 may include records of authentication data, associated with individuals or groups, which are authorized to interact with the data storage device 1 for additional functions 67.

The authentication data set may be based on data entered during enrolment of user(s). In other examples, the data storage device 1 may be supplied with some authentication data, such as a master password and other authentication data for administrators.

In some examples, the authentication data set 65 is be stored local on the data storage device 1, such as in configuration memory 26. In other examples, at least part of the authentication data set 65 may be stored in the storage medium 19 in encrypted or unencrypted form. This enables authentication by the data storage device 1 without relying on a network or other external systems.

### USB Cable

Communication between the data storage device 1 and the host device 5 can be enabled by a physical connection. In the illustrated example, this includes a cable 28 in accordance with the universal serial bus (USB) standards. This can include USB 2.0, USB 3.0, USB4, etc. In this example, the host device 5 that is connected to the USB bridge 31 would see two USB peripheral devices.

In some examples, the USB cable 28 has ends including one or more of the following connectors:
a. USB-A
b. USB-B
c. Mini-USB B
d. Micro-USB B
e. Micro-USB 3.0
f. USB-C
g. Thunderbolt 1
h. Thunderbolt 2

Referring to FIG. 4, the first device would be the emulated network adapter 9 in communication with the host device 5 through the first communication channel 20, as a logical pipe 24 through the USB cable 28. The second device would be the mass storage device 13 in communication with the host device 5 through the second communication channel 22, as a logical pipe 24 also through the USB cable 28. Thus the one physical USB cable 28 functionally carries both logical communication channels 20, 22. This can be convenient for a user who can make one physical connection to establish both channels.

### Host Device

The host device 5 may include any computing device, electronic device, or electronic computing device that can host a peripheral device and has a web browser 12. Such host devices 5 can include desktop computers, laptop computers, tablet computers, cellular phones, televisions, set top boxes, gaming consoles, electronic books (e-reader), etc.

Referring to FIG. 2, the host device 5 includes a processor 38, a memory 39, and a communication interface 37. The processor 38 may comprise one or more processors that are, in combination or individually, configured to execute program code stored within the memory 26 to issue commands for controlling operation of the host device 5. The communication interface 37 enables the host device 5 to communicate with the data storage device 1 and may further enable the processor 38 to issue commands to the data storage device.

The host device may also include user interfaces, such as a monitor, keyboard, mouse, touchscreen, etc.

The memory 39 of the host device may be configured to include a web browser application 12. Generally, the web browser 12 is configured to open web pages in a network environment. In some examples, this includes communicating in a network environment via hypertext transfer protocol (HTTP).

In addition, the web browser 12 is configured to interact with web applications 17 or run web applications. This can include running scripts in languages such as HTML, CSS, JavaScript. In some examples, the memory 39 of the host device 5 may receive such scripts and web applications from the data storage device 1 that, in turn, are operated in the web browser 12.

The memory 39 may also include drivers 32b, 34b to enable the processor 38 to communicate and operate the emulated network adapter 9 and the mass storage device 13 of the data storage device 1.

### Drivers

Referring to FIG. 1, both the data storage device 1 and the host device 5 include respective device drivers. There are two categories: (i) a USB mass storage driver (34a, 34b) and (ii) Ethernet over USB protocol driver (32a, 32b).

Ideally, the device drivers at the host device 5 side are generic drivers that are provided in the operating system of the host device. This can advantageously enable functionality with the data storage device 1 without having the user to install a bespoke driver to use the data storage device.

### USB Mass Storage Driver 34a, 34b

The USB mass storage driver 34a, 34b may include a driver compatible with USB mass storage device class (e.g. USB MSC, UMS). These are typically drivers that enable a host device to communicate with a USB device that is an external data storage device (such as an external hard drive, external flash drive, solid state drives, memory cards, etc).

Such USB mass storage drivers are provided natively to operating systems of host devices for ease and efficiency.

The USB mass storage driver 34a, 34b enables communication through the second communication channel 22 to send and receive data via the second endpoint set 35 associated with the mass storage device 13.

Ethernet Over USB Protocol Driver 32a, 32b (e.g. CDC-NCM)

The Ethernet over USB protocol driver 32a, 32b is a driver configured to enable a host device to communicate with an ethernet connection over a USB link.

The USB mass storage driver 34a, 34b enables communication through the first communication channel 20 to send and receive data via the first endpoint set 33 associated with the mass storage device emulated network adapter 9.

Examples of such drivers include NCM (Network Control Model) that is part of CDC (Communication Device Class). Generally, these drivers enable the host device to communicate with other networked devices over HTTP.

The CDC-NCM is a part of the USB class drivers standard that provides a method for network-capable USB devices to manage network traffic. The NCM effectively bridges network data traffic at higher speeds over a USB interface, enabling USB network devices to reach closer to their full speed capabilities. CDC-NCM is implemented as part of the USB standard and it is to be appreciated that in addition to USB revisions (such as USB 2.0, 3.X and USB4), further revisions of USB standards may also utilize CDC-NCM suitable for the presently disclosed method and data storage device.

Advantageously, CDC-NCM is included in many contemporary operating systems of host devices 5.

Compared to other Ethernet over USB drivers, CDC-NCM has efficiency in handling high-speed data transfers and its broad compatibility with various devices and operating systems. CDC-NCM provides a balance of performance and reliability for network communication over USB.

It is to be appreciated that other Ethernet over USB drivers and systems could be used, such as RNDIS (Remote Network Driver Interface Specification offered by Microsoft), Ethernet Control Module (ECM), Ethernet Emulation Model (EEM).

### Lightweight IP 36

Referring to FIG. 1, a lightweight IP (lwIP) 36 provides a TCP/IP protocol layer implementation between the Ethernet over USB protocol driver 32a and emulated HTTP server 16.

The lwIP 36 may be a customised layer for the data storage device 1. Advantageously, lwIP is used for memory constrained devices as it provides the networking layer, TCP/IP implementation, and web server to implement a web-application-based interface for authentication and other security commands for the data storage device 1. Since there the USB protocol driver 32a (such as an NCM driver) is below the lwIP 36, it is possible to use customised lwIP 36 without having to use specialised drivers or other software or firmware at the host device 5 to translate the data.

The TCP/IP (Transmission Control Protocol/Internet Protocol) stack is a lower-level layer that underlies HTTP. It ensures data packets are properly routed across networks, provides error-checking and reliability, and handles IP addressing and port management. From the user and host device perspective, when using HTTP 48, this operates over the TCP/IP 49 stack to transmit data between the browser 12 and the web server/HTTP server 16.

### HTTP Server 16

The lwIP 36 can also provide a simple HTTP server 16 to enable the host device 5 to communicate to the data storage device 1 via the web application 17. This includes transmitting and receiving data, via the first communication channel 20, in accordance with Transmission Control Protocol (TCP) or User Datagram Protocol (UDP).

In some examples, the emulated HTTP server 16 may host the web application 17. This may include server-side scripts (like Python, PHP or ASP). In some examples the HTTP server 16 is configured to send the web application 17 to the host device 5 via the first communication channel 20.

### Emulated Network Adapter 9

Referring to FIG. 1, the example emulated network adapter 9 is emulated by a combination of the driver 32a, lwIP 36 and emulated HTTP server 16. It is to be appreciated that alternative computer-implemented methods in software and/or firmware could be used to enable the processor 7 to emulate another example of an emulated network adapter 9.

### Web Application

The web application 17 may be instantiated at a browser 12 of the host device. In some examples, the web application 17 is a client-side script running on the host device 5 (where the host device is a client of the emulated HTTP server 16). In other examples, the web application 17 runs, at least in part, as a server-side script running at the emulated HTTP server where the browser 12 at the host device 5 operates as a terminal. It is to be appreciated in some examples, the web application 17 may be distributed where execution of the program is performed at both the data storage device (hosting the emulated HTTP server 16) and at the host device 5 (with the browser 12).

The use of a web application 17 in a browser 12 increases flexibility and ease of use as many host devices 5 include a browser 12. This can enable host devices 5 using various operating systems to use the data storage device 1 without having to install a proprietary drivers or other applications.

In some examples, the web application 17 comprises, at least in part, hypertext markup language (HTML). This can include HTML5. In other examples, the web application can be based on CSS (Cascading Style Sheets), JavaScript, etc. In other examples, the web application includes server-side scripts (e.g. PHP (Hypertext Preprocessor) or ASP (Active Server Page)). In some examples, Flask (a Python-based web framework) is used to build the server-side web application.

### Method

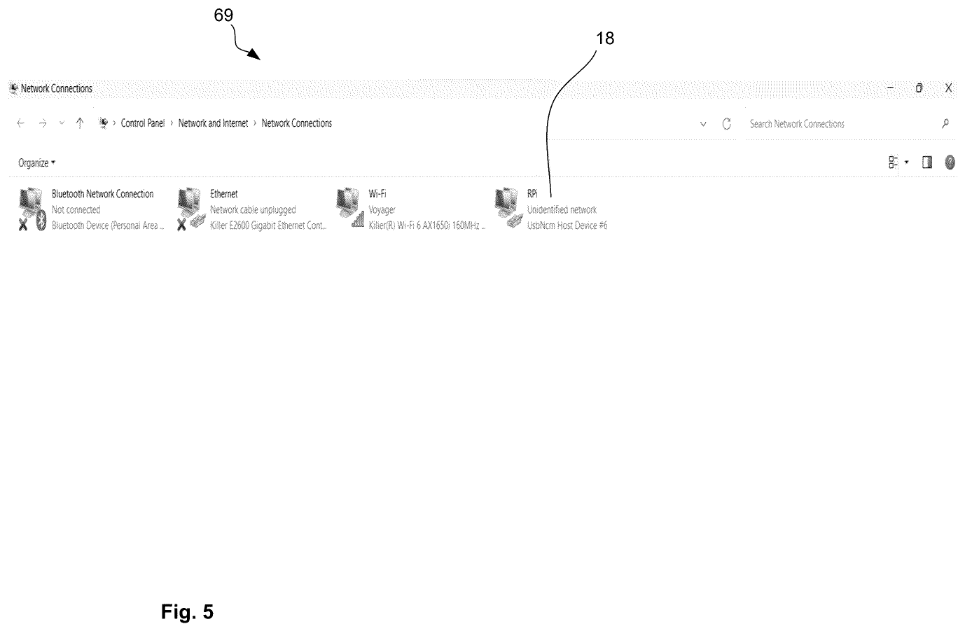

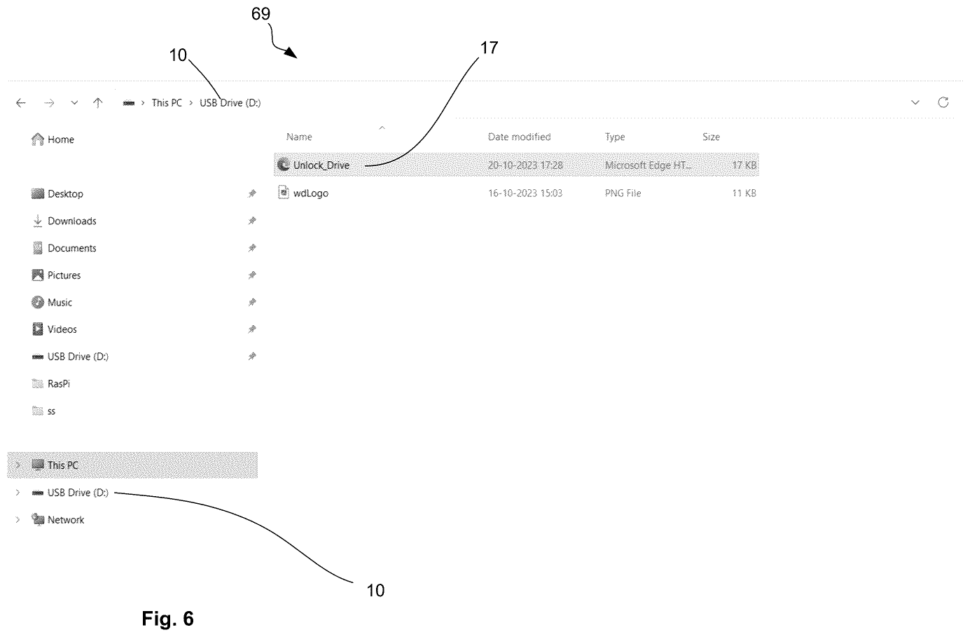

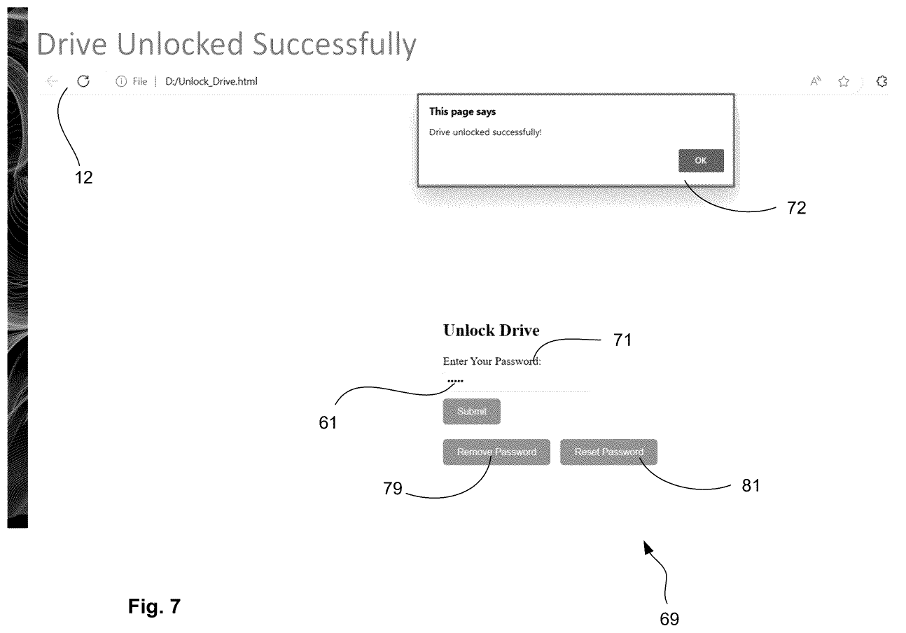

An example of a process of establishing communication with the host device will now be described. FIG. 3 shows a flow diagram of the method 100. FIGS. 5 and 6 illustrate a user interface 69 of the host device 5 during communicative coupling. FIGS. 7 to 11 are representations of the web application 17 in a browser 12 that is shown at a user interface 69 of the host device 5.

### Coupling the Host Device 5 With the Data Storage Device 1

The process includes communicatively coupling the host device 5 with the data storage device 1 and part of this process includes connecting the cable 28 between the respective communication interfaces 3, 37.

The USB (universal serial bus) bridge 31 enumerates with the host device 5 such that there are two peripheral devices, namely a network adapter 9 and a mass storage device 13 as illustrated in FIG. 4.

The network adapter 9 (as an emulated network adapter) is established by communicatively coupling 110 with the host device 5 via the first communication channel 20. This first communication channel 20 is enabled by the Ethernet over USB protocol driver 32a, 32b. FIG. 5 illustrates a user interface 69 showing the connected networks, including the emulated network 18 using the first communication channel 20 and Ethernet over USB protocol driver 32a, 32b.

### First Example—Web Application In Unsecured Partition 10

In some examples, the process includes communicatively coupling with the host device 5 to enable access to an unsecured partition 10 of the storage medium 19 of the data storage device 1. This can include access to the unsecured partition 10 as a mass storage device 13 that can be read by a host device 5 without having to unlock the data storage device 1. This unsecured partition 10 is used to store shared data, such as a copy of the web application 17. In other examples, the unsecured partition 10 may be used to store user instructions, hyperlinks, or other information to assist the user to initialise or otherwise use the data storage device 1 and web application 17.

FIG. 6 illustrates an example of the user interface 69 browsing the unsecured partition 10 of the storage medium and where the unsecured partition 10 stores a copy of the web application 17 (named “Unlock_Drive.html”). The operator may select the web application 17 so that the web application 17 is sent 130′ from the unsecured partition 10 to the host device 5 via the second communication channel 22.

In some examples, the web application 17 is stored in the unsecured partition 10 of the storage medium 19 of the data storage device is read-only and/or write protected. This can prevent deleting or otherwise compromising the web application 17. In further examples, the unsecured partition 10 is read-only.

Thus the web application 17, which in this case is in the form of an HTML script, is opened using a browser application 12 of the host device 5. This can include running the application 17 as a predominately client-side web application.

### Second Example—Web Application Hosted at HTTP Server 16

In another example, the web application 17 is hosted at the emulated HTTP server 16 and the web application 17 is accessed by the browser 12 via the first communication channel 20 and the emulated network adapter 9. This can include entering a URL (uniform resource locator) at the browser 12 to request, or otherwise access, the web application 17.

The emulated HTTP server 16, in response to receiving 125 a request to access the web application 17, sends 130 the web application 17 to the host device 5. This includes sending (at least in part) the web application 17 via the first communication channel 20.

In some examples, the web application 17 may be stored in the storage medium 19. This may include the unsecured partition 10 as noted above, wherein the emulated HTTP server 16 in turn sends the web application 17 to the host device 5. In other examples, the web application 17 is stored in a further memory 26 (such as memory 26) separate to the storage medium 19.

In some examples, the web application 17 is run, at least in part, at the server-side (i.e. at the emulated HTTP server 16). A representation of the web application 17 is, in turn, sent to the host device 5. This enables a user to interact with the web application 17 at the browser 12.

### Other Examples—Web Application Accessed Via Other Means

In yet other examples, the web application 17 may be received at the host device 5 via other means. One variation includes downloading the web application 17, via a network, such as the internet. This can include a server (including a cloud server) that has the web application 17 available for download.

In another example, the web application 17 is stored in the memory 39 of the host device 5. This can include a previously downloaded copy of the web application 17 from the internet, or a previously received copy of the web application from the unsecured partition 10.

### Unlocking Drive

FIG. 7 illustrates a representation of an instantiation of the web application 17 at the browser 12. This include a prompt 71 to enable a user to enter authentication data 61, such as a password. In some examples, this can also include a username which can be useful where the data storage device is enabled for multiple users.

The authentication data 61 is then transmitted, via the first communication channel 20, and received 140 at the data storage device 1. The authentication data 61, in some examples, is transmitted in accordance with TCP and/or UDP protocols.

The data storage device 1 verifies 150 that the received authentication data 61 corresponds to a record 63 in an authentication data set 65. This can include comparing the received authentication data to records 63 saved during enrolment of user(s). The authentication data set may be stored in the configuration memory 26.

In response to verifying 150 the authentication data 61 corresponds to a valid record 63 (such as an authorized user), the method 100 includes selectively enabling access 160 between the host device 5 and a secured partition 8 of the storage medium 19 via the second communication channel 22.

In some examples, this includes making the secured partition 8 available part of the mass storage device 13. In alternative examples, this can include enumerating a further mass storage device 13 (such that from the host device perspective there are three peripheral devices being: the emulated network adapter 9, a mass storage device for the unsecured partition 10, and another mass storage device for the secured partition 8).

From the host device 5 perspective, once the data storage device 1 is unlocked such that access is enabled to the secured partition 8 of the storage medium 19, the secured partition 8 can be used as mass storage device 13. In some examples, it is not necessary for further interaction with the browser 12 or web application 17 during the same session to access the secured partition 8. In some examples, the session ends, and the drive is automatically locked again if the cable 28 is disconnected. In other examples, the session ends when the data storage device 1 is locked via the web application 17 (discussed in a separate section below).

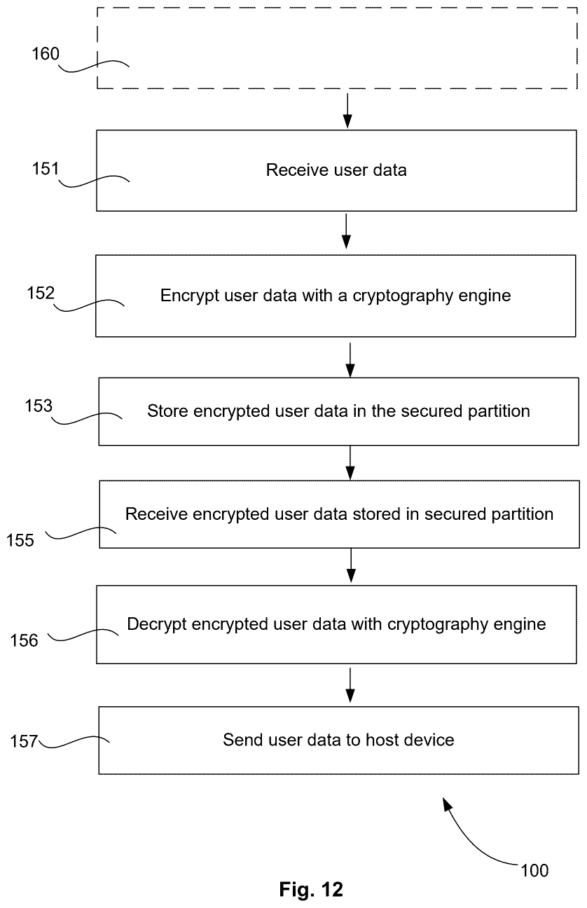

In some examples, enabling access 160 can include enabling access to encrypted user data stored in the secured partition 8. This can have particular application to examples where the data storage device 1 is a self-encrypting drive (SED). This can be enabled by a cryptography engine 23 configured to encrypt and decrypt user data. Referring to FIG. 12, the method 100 may include receiving 151 user data from the host device 5 and, in response encrypting 152 the user data to encrypted data with the cryptography engine 23. The encrypted user data is the stored 153 in the secured partition 8 of the storage medium 19.

When the authenticated host device 5 requests the user data, this include receiving 155 encrypted user data stored in the secured partition 8 and, in response decrypting 156 the encrypted user data to user data with the cryptography engine 23. The method 100 further includes sending 157 the user data to the host device 5 via the second communication channel 22.

### Lock Drive

The data storage device 1 may be selectively locked. In some examples, the data storage device 1 may be configured to automatically lock the device when the cable 28 is disconnected to from either the data storage device 1 and/or host device 5. In further examples, the data storage device is configured to lock the device after a specified time of inactivity. For example, if no read/write/erase activity occurs for 15 minutes, 30 minutes, 1 hour, etc.

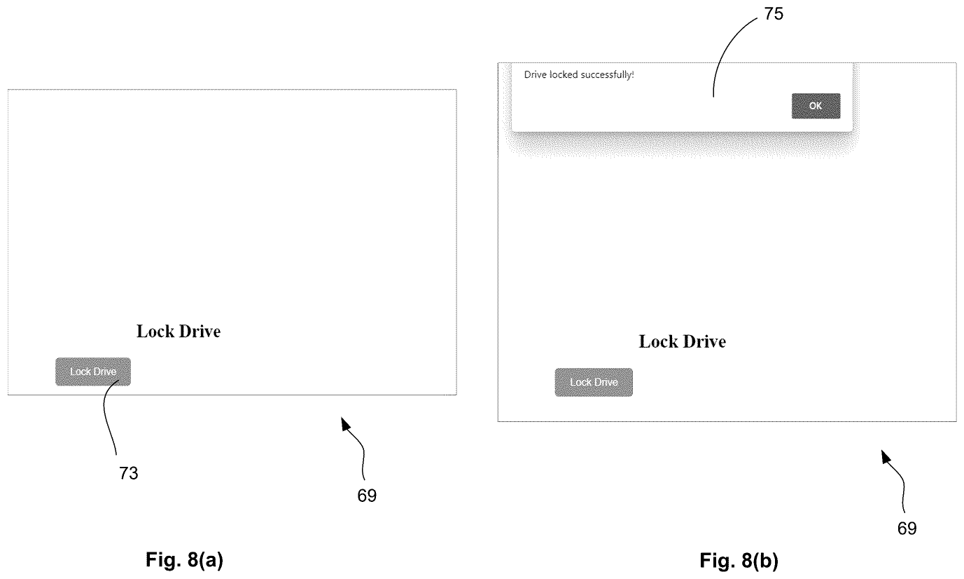

In yet further examples, the web application 17 includes an option for a user to lock secured partition 8. Referring to FIG. 8(a), after a user has unlocked the drive the web application 17 displays a representation with a graphical user interface icon 73 to lock the drive. Upon selecting the icon 73, this sends a lock command via the first communication channel 20 to the data storage device 1. In response, the data storage device 1 disables access between the host device 5 and the secured partition 8 of the storage medium.

In some examples, a confirmation message 75 is sent, via the first communication channel 20, to the host device that is displayed in the web application 17 as illustrated in FIG. 8(b).

### Initialization and Setting Password

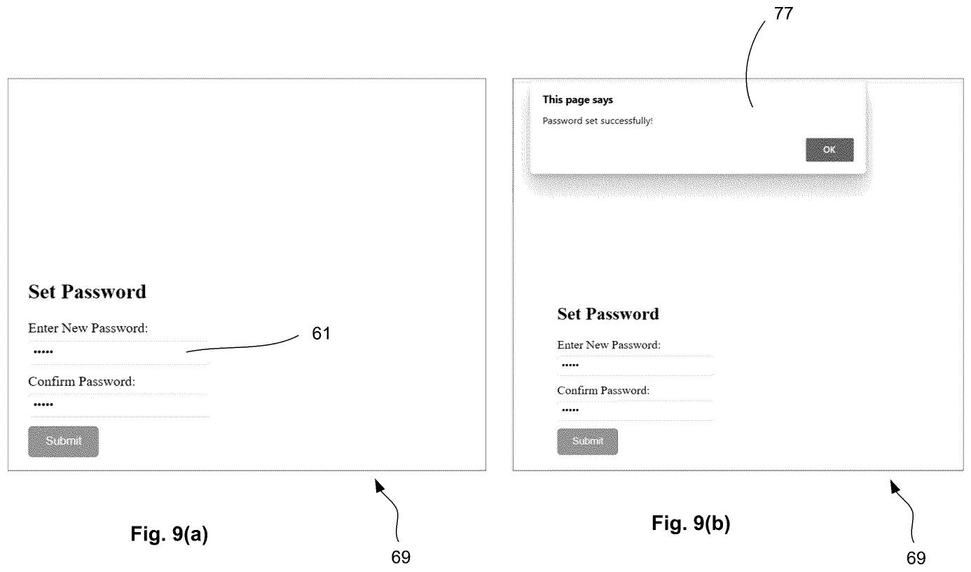

FIG. 9(a) illustrates an example of enrolling a user and their corresponding password as authentication data. This includes a prompt for a user to enter their desired password 61 in the web application 17. Although this example only includes a password, it is to be appreciated that a user identifier in conjunction with a password can form the authentication data 61. The desired authentication data 61 is then sent from the host device 5 to the data storage device 1, wherein the processing device 7 stores the authentication data 61 as part of the authentication data set 65. In some examples the processor 7, or the instantiated web application 17, may check the desired authentication data before storing it. This may include checking that the authentication data 61 is properly formed and meets requirements such as minimum length and/or complexity.

Upon successful enrolment of the authentication data, a notification 77 may be sent from the data storage device 1 to be displayed at web application 17 in the browser as shown in FIG. 9(b).

In some examples, multiple passwords (e.g. multiple records in the authentication data set) can be stored in the data storage device 1 to enable multiple users to have access to the secured partition 8.

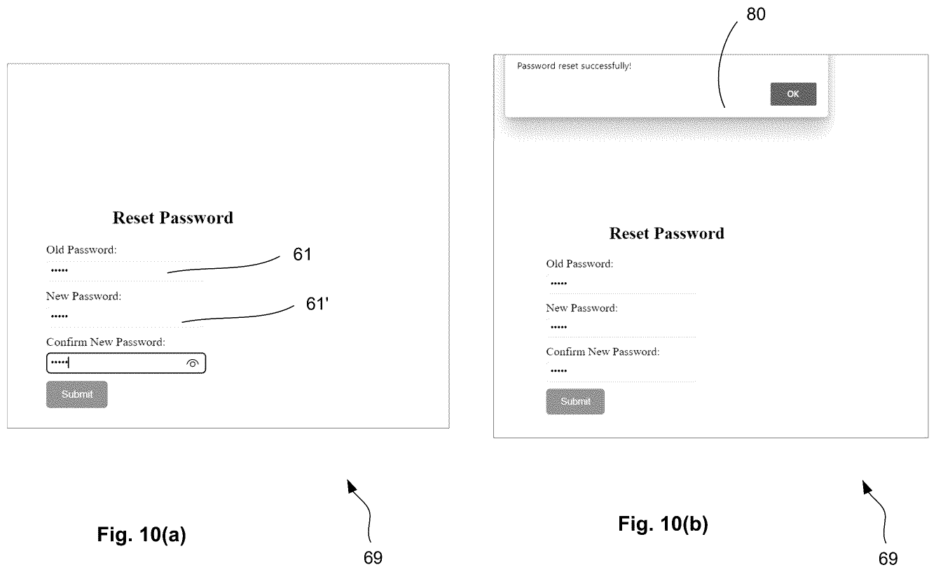

In further examples, a password 61 may be removed 79 or reset 81. FIG. 7 illustrates these selectable options during unlocking of the data storage device 1. FIG. 10(a) illustrates an example of the web application 17 providing an interface for a user to enter their existing password 61 and reset it with a new password 61′ as authentication data. The authentication data 61, 61′ is then sent to the data storage device 1 and upon verifying the existing password 61, the new password 61′ can be stored as part of the authentication data set. A notification 80 of successful reset is sent to a representation of the web application 17 in the browser 12 as shown in FIG. 10(b).

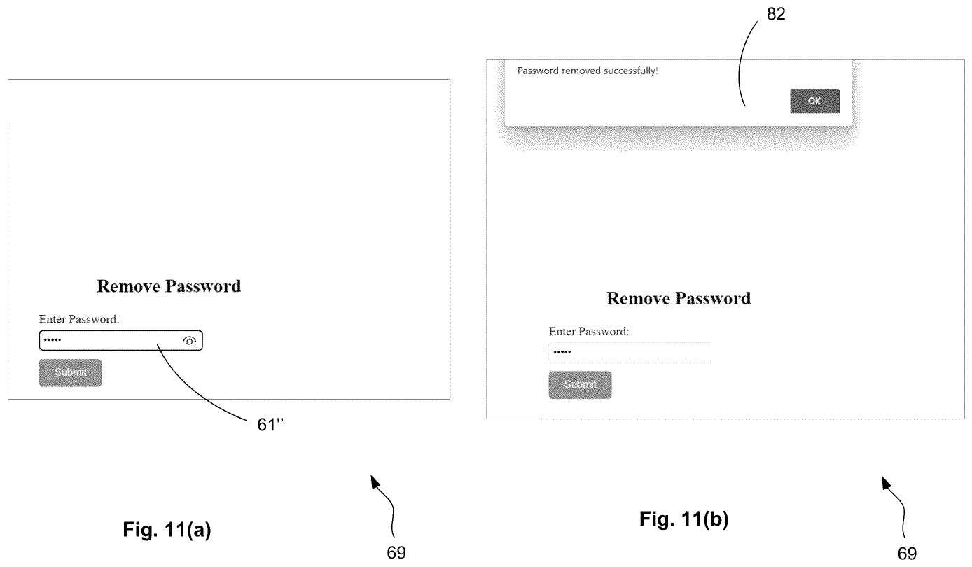

FIG. 11(a) illustrates an example of the web application 17 providing an interface for removing 79 a password 61″. This may be useful in cases where there are multiple passwords for multiple enrolled users, and it is desirable to remove one of the passwords if one of the users should no longer have access to the secured partition 8. The authentication data 62″ to be removed is then sent to the data storage device 1 and upon successful removal of the respective record 63 from the authentication data set 65, a notification 82 is sent to a representation of the web application 17 in the browser as shown in FIG. 11(b).

The above described commands are security commands and these are sent and received between the data storage device 1 and the host device 5 via the first channel 20. This can include securely sending these security commands over HTTP and enabled by the TCP and UDP protocols at the lwIP.

### Advantages

The present disclosure includes using a web-based interface accessed through a web browser to manage a data storage device, such as a USB drive. Users can perform actions like locking and unlocking the data storage device's content stored in the storage medium securely through this interface.

Examples of the presently described data storage device 1 and method 100 can offer cross-platform compatibility. Instead of requiring operating system specific applications (e.g. an application for each of Windows, MacOS, and other operating systems) and drivers, the web-based interface can be accessed from any platform (host device) with a web browser.

In addition, there is reduced complexity. By removing operating system specific applications can streamline USB drive management for both end-users and information technology administrators. This includes reducing or removing the requirement to maintain different software versions or worry about compatibility issues with different operating systems.

In some examples, this described data storage device and method enhances security. This can include leveraging browser security features such as sandboxing and HTTPS (HTTP Secure) to provide a secure environment for USB drive management and protecting data from unauthorized access and threats.

In some examples, the method and data storage device users CDC-NCM drivers for sending security commands between data storage device and the host device.

Advantageously, the CDC-NCM driver is supported by major operating systems and by a wide range of USB host devices. This assists in compatibility with a wide range of hardware and software.

### Variations

In the example illustrated in FIGS. 1 and 2, the first communication channel 20 and the second communication channel 22 are carried through a shared physical cable 28. It is to be appreciated that in one alternative, the first communication channel 20 is carried via a cable 28. However, the second communication channel 22 is via an alternative means, such as via Wi-Fi. That is, the mass storage driver 34b is configured to send and receive user data via a wireless Wi-Fi network.

### Unlocking a Data Storage Device Using a Web Application

Embodiments utilizing a web application to unlock a data storage device are described herein. These embodiments relate to alleviating, or at least providing a useful alternative to, difficulties associated with traditional unlocking methods of the data storage device, such as the need to install specialized software on the host device or compatibility issues across different operating systems. By leveraging a lightweight web application, the unlocking process is streamlined, eliminating the requirement for specialized software installation and ensuring accessibility across a wide range of host devices, including those with limited resources or without internet connectivity.

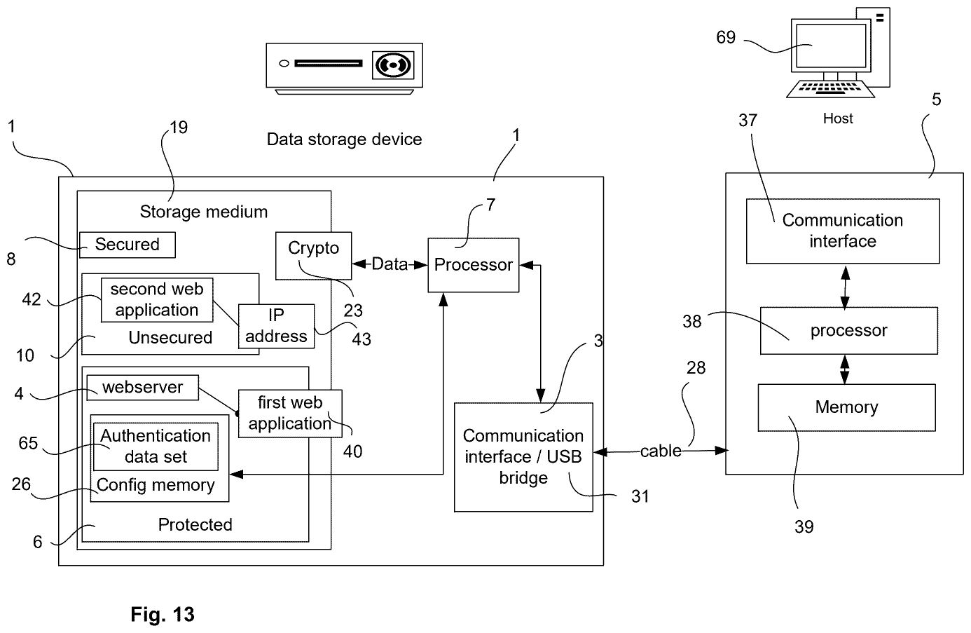

As illustrated in FIG. 13, an example of a data storage device 1 configured to be communicatively coupled with and unlocked by a host device 5 will now be described. The schematic of data flow and technology topology, and components of the device are similar to those illustrated in FIGS. 1 and 2, respectively.

The DSD 1 includes a storage medium 19, including at least a protected partition 6, a secured partition 8 and an unsecured partition 10. The protected partition 6 is configured to be inaccessible through a mass storage device protocol. In some embodiments, the system configurations of the DSD 1 are stored in the protected partition 6 so that a general user cannot access the protected partition 6 through a mass storage device protocol used for user data accessing and transmission, such as the Advanced Technology Attachment (ATA) protocol, the Serial ATA (SATA) protocol, and Small Computer System Interface (SCSI) protocol.

In one embodiment, the protected partition 6 is defined under the TCG (Trusted Computing Group) Opal Storage Specifications (e.g., TCG Opal 2.0), which allow logical block addressing (LBA) ranges to be created in the storage medium of the DSD and assign different permissions for each LBA range. In this embodiment, an LBA range corresponding to the protected partition 6 is configured to be inaccessible to any user.

In another embodiment, the protected partition 6 is defined under the Access Control List (ACL) protocol that allows or rejects data access requests to specific LBAs based on user privileges. In this embodiment, the LBA corresponding to the protected partition 6 may only be accessible by the operator with high privilege (e.g., a manufacturer), as predefined by the Access Control Lists.

The protected partition 6 stores program code, when executed, to emulate at least a webserver 4 configured to provide a first web application 40 to a browser 12 of a host device 5 to configure 220 the DSD 1. The first web application 40 may include an interactive graphical user interface (GUI) accessible via the browser 12, enabling a user to initially configure the DSD 1 and manage various existing configurations of the DSD 1. In some examples, the first web application 40, or part of the web application, may be stored in the protected partition 6. This may include server-side scripts of the web application run on the at least one processor 7 to emulate the webserver 4. In other examples, this may also include client-side scripts that are sent 225 to the host device 5, by the at least one processor 7 via the control communication channel 20.

In one embodiment, the webserver 4 is implemented as an HTTP server that can be accessed through the Uniform Resource Locators (URLs) of web applications, and deliver the content of these web applications to the host device 5. By utilizing the webserver 4 hosted within the protected partition 6, the system enhances security by isolating critical configuration operations and configuration data from the general file access functionality of the DSD 1.

In some embodiments, the users with high privilege (e.g., a manufacturer or a system administrator) can access the first web application 40 through providing a specific URL associated with the first web application 40. This specific URL is typically restricted and inaccessible to non-privileged users (e.g., those using the DSD solely for data storage), ensuring that only authorized personnel can access advanced configuration and security settings.

In some examples, this specific URL is dynamic. For example, the URL may be generated dynamically based on a cryptographic hash function using a session-specific identifier, or a time-based algorithm. Alternatively, the URL may be periodically updated and distributed securely to authorized users via an authentication server, similar to the mechanism used in two-step authentication.

In further embodiments, after providing the specific URL associated with the first web application 40, one or more further authentication processes are required to access the first web application 40 to ensure that even if the specific URL is exposed unintentionally, the first web application 40 is inaccessible to unauthorised users. Examples of such authentication processes include multi-factor authentication (MFA), such as a one-time password (OTP) sent via email or SMS, biometric authentication (e.g., fingerprint or facial recognition), challenge-response authentication using security questions, or cryptographic key-based authentication, where users must provide a digital certificate or a private key.

The secured partition 8 is configured to store user data under the mass storage device protocol such as the USB Mass Storage Class (MSC) protocol. User data may be stored in the secured partition 8 in the form of files, directories, or databases, accessible through standard operating system interfaces of the host device 5. For example, the partition can store multiple files, which can be accessed and modified by the host device 5 through the interface of the file system. Additionally, the partition 8 may support advanced use cases, such as storing encrypted user data, where the encryption credentials (e.g., keys and passwords) are managed by the first web application 40 in the protected partition 6 or an external encryption mechanism. In one embodiment where the DSD 1 is a NAND flash, Backend (BE) firmware 52 is used for handling authentication, encryption key management, and security enforcement for the Self-Encrypting Drive (SED), as defined by the TCG Opal Security standard.

The unsecured partition 10 is readable by the host device 5. That is, the host device 5 can read data from the unsecured partition without unlocking the DSD 1. The unsecured partition 10 stores at least a second web application 42, which is different from the first web application 40. The second web application 42 is executable through the browser 12 of the host device 5 to unlock the data storage device 1. In one embodiment, as shown in FIG. 6, the second web application 42 is implemented as an HTML (Hypertext Markup Language) file (e.g., named “Unlock_Drive.html”), which can be instantiated in the browser 12 of the host device 5 (by the user double-clicking the HTML file). This advantageously enables the second web application 42 to be easily available to a host device.

In some examples, this is useful for storing data that is freely readable. This can include storing a third web application to initiate the second web application 42. In those examples, the further unsecured partition 10 may, from the perspective of the host device 5, appear as a mass storage device that is accessible after the cable 28 is connected to the respective communication interfaces 3. This can enable the host device 5 to request a copy of the second web application 42 from the unsecured partition 10. Subsequently, the second web application 42 is sent 225 from the unsecured partition 10 to the host device 5, via the control communication channel 20. The second web application 42 can then run on a browser 12 of the host device 5.

It may be advantageous for the second web application 42 to be write-protected.

This can include specifically write protecting the second web application 42. In further examples, this can include write-protecting (or otherwise specifying read-only) for the unsecured partition 10. This can prevent the second web application from being inadvertently, or deliberately, deleted or altered.

Referring to FIG. 13, the DSD 1 further includes a communication interface 3 configured to communicate with a host device 5 which in some examples includes a universal serial bus (USB) bridge configured to transmit and receive data via a USB interface 28 to the host device 5. The USB interface may include a physical cable and corresponding USB connectors. The DSD 1 also comprises at least one processor 7 configured to, individually or in combination, execute program code stored within a memory 26 to issue commands for unlocking the data storage device 1. Firmware associated with the at least one processor 7 may be stored in the protected partition 6.

The communication interface 3 enables communication between the data storage device (DSD) 1 and the host device 5. In one example, one function of the communication interface 3 is to provide a wire-based data port between the host device 5 and components of the DSD 1. In a preferred example, the communication interface 3 includes a USB (universal serial bus) bridge 31 to enumerate with the host device 5.

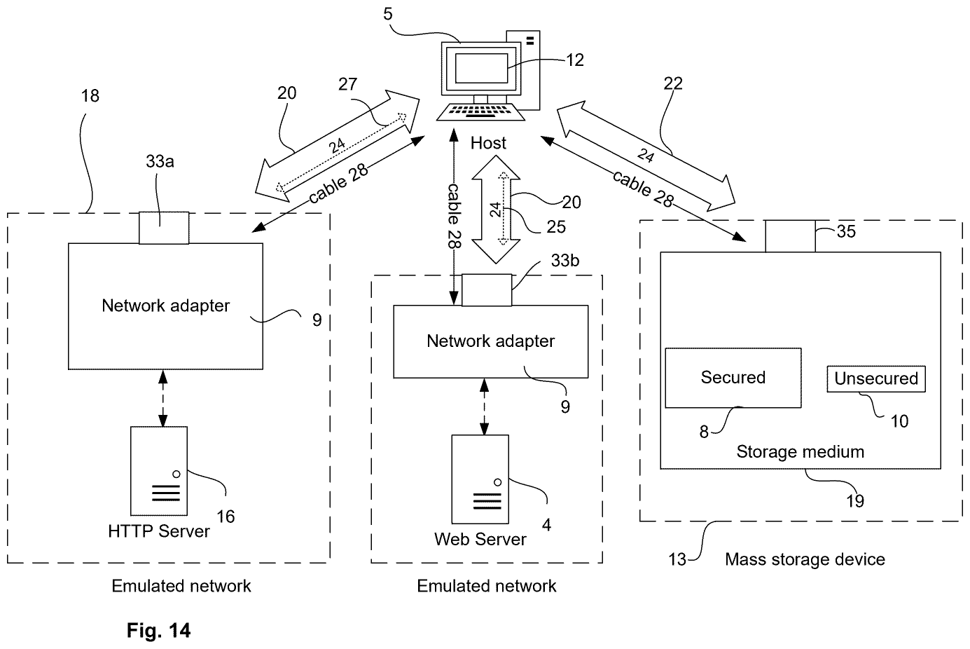

In use, the DSD 1 can appear, from the perspective of the host device 5, as two different downstream peripheral devices, as illustrated in FIG. 14. That is, the communication interface 3 can function as a USB hub. One peripheral device is as a mass data storage device 13, allowing the host to use the storage medium 19 to store, read, and write, user content data. The other peripheral device is where the at least one processor 7 emulates a network adapter 9 and an emulated HTTP server 16 in an emulated network 18. In some embodiments, the emulated HTTP server 16 couples to the webserver 4 in the protected partition 6 as an additional server, providing enhanced flexibility and scalability for managing web applications. In other embodiments, the emulated HTTP server 16 and the webserver 4 are implemented as the same server for a compact configuration, enabling seamless interaction with the user through the browser 12.

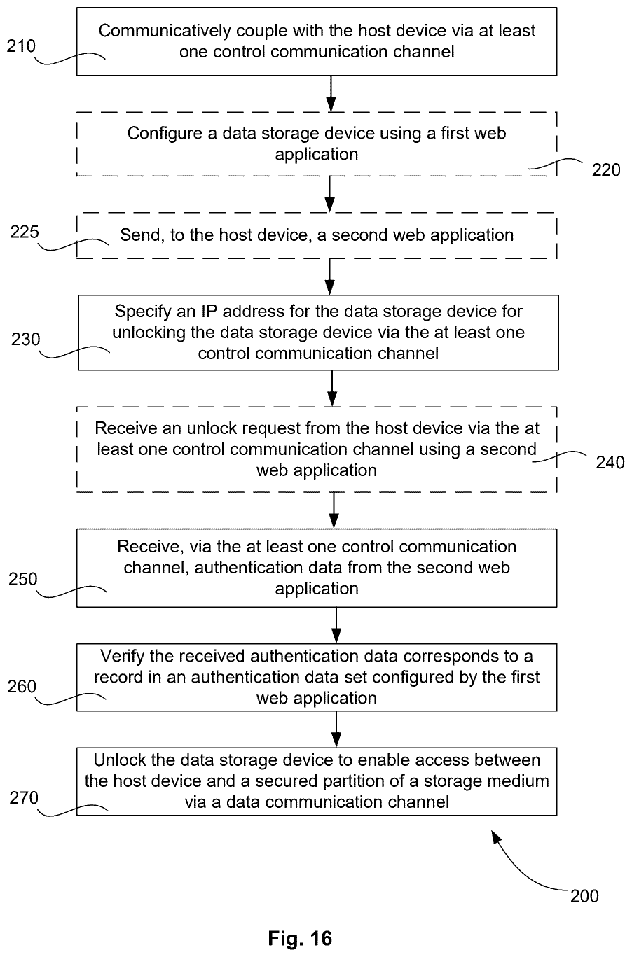

As illustrated in FIG. 16, an example of a process for unlocking a data storage device 1 using a host device 5 will now be described.

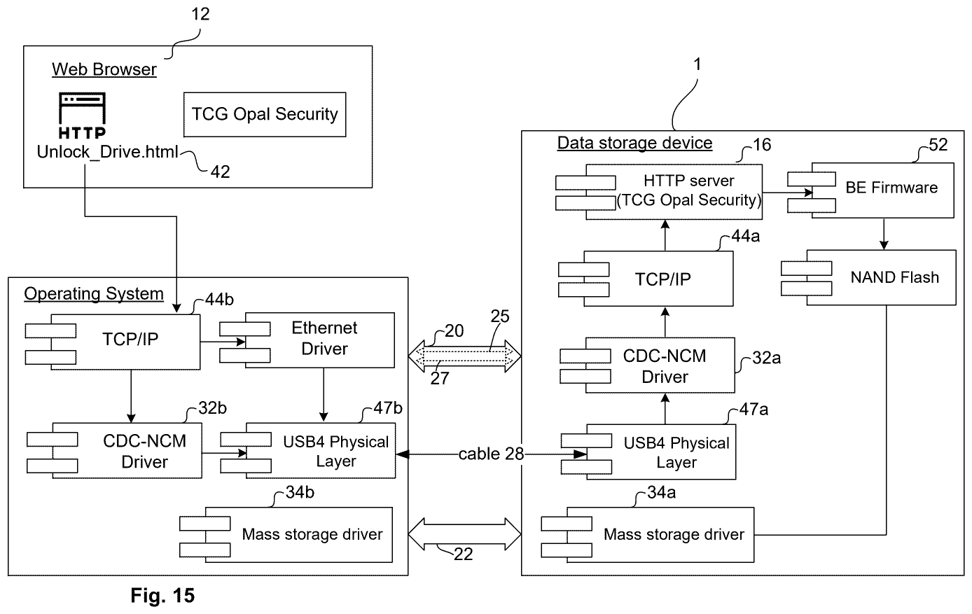

At step 210, the at least one processor 7 is configured, individually or in combination to communicatively couple 210 with the host device 5, via at least one control communication channel 20, as shown in FIGS. 13 and 15. The at least one processor 7 is configured to emulate a network adapter 9 to the host device 5, wherein the at least one control communication channel 20 is enabled by an Ethernet over USB (Universal Serial Bus) protocol driver (32a, 32b).

In one embodiment, as illustrated in FIG. 15, the Ethernet over USB protocol driver is a CDC-NCM (Communications Device Class Network Control Model) driver 32a, 32b that can emulate a virtual Ethernet network over USB interface as if the DSD 1 is connected to a network so that the DSD 1 can communicate with the host device 5 under an IP protocol (e.g., UDP, TCP, FTP, HTTP, etc.). This can be advantageous in that CDC-NCM drivers are provided on a wide variety of operating systems in contemporary host devices 5. This can include Windows and MacOS for laptop and desktop computers, as well as operating systems of mobile devices including some tablet devices and smartphones. Therefore, examples of the data storage device 1 can be used with a host device 5 without requiring special drivers to be installed on the host device 5.

To enable unlocking the DSD 1 via the at least one control communication channel 20, the second web application 42 is configured to specify 230 an IP (Internet Protocol) address 43 for the DSD 1. The IP address for the DSD 1 enables the DSD 1, through the second web application 42, to communicate with the host device 5 using standard IP-based protocols (e.g., UDP, TCP, FTP, HTTP, etc.). In some embodiments, the first web application 40 also configures the DSD 1, as described earlier, via the at least one control communication channel 20.

Once the IP address is specified, the DSD 1 can communicate with the host device 5 via the emulated network 18. For example, the second web application 42 may use HTTP to facilitate a secure web-based interface in the browser 12 for the following unlocking operations.

At step 240, the at least one processor 7 may receive 240 an unlock request 50 from the host device 5 via the at least one control communication channel 20 using the second web application 42. The unlock request 50 may be proactively input by a user through the host device 5. For example, the user may interact with an interface displayed in the browser 12 of the host device 5, such as by selecting an “Unlock” icon or button. In some embodiments, the interface may present a user-friendly graphical element, such as a dialogue box or a form, prompting the user to initiate the unlocking process.

In response to receiving 240 the unlock request 50, the second web application 42 initiates a first interface in the browser 12 of the host device 5. The first interface is configured to receive the authentication data 61 to unlock 270 the data storage device 1 from the host device 5, as shown in FIG. 7.

In some embodiments, the second web application 42 is configured to automatically initiate the user interface in the browser 12 of the host device 5 in response to the at least one control communication channel 20 being established. For example, upon successful detection of the host device 5 and initialization of the at least one control communication channel 20, the user interface may be proactively displayed in the browser 12, prompting the user to enter authentication data 61. The automatic initiation eliminates the need for the user to manually input the unlock request 50.

At step 250, the at least one processor 7 receives 250 authentication data 61 to unlock the data storage device 1 via the at least one control communication channel 20. The authentication data 61 is received from the second web application 42 instantiated at the browser 12 of the host device 5. In some examples, the authentication data 61 is in the form of one or more passwords (e.g., a user password and/or a two-factor authentication password), as shown in FIG. 7. Alternatively, the authentication data 61 can also be a private key that will be further used in a cryptographic process, such as a hash calculation based on the private key and a public key associated with the DSD 1.

At step 260, the at least one processor 7 verifies 260 that the received authentication data 61 corresponds to a record in an authentication data set 65 stored in the protected partition 6, as previously configured by the first web application 40. For example, in the embodiments where the authentication data 61 is in the form of one or more passwords, the processor 7 compares the received password(s) with corresponding entries stored in the authentication data set 65. Alternatively, in the embodiments where the authentication data 61 is a private key, the processor 7 applies a cryptographic process (e.g., hashing the received private key with the public key associated with the DSD 1), and compare the result from the cryptographic process with the corresponding entry (e.g., a hash value) stored in the authentication data set.

In the embodiments where the Ethernet over USB protocol driver 32a, 32b is a CDC-NCM driver 32a, 32b, the unlock request 50 and the authentication data 61 from the host device 5 are received from the CDC-NCM driver over the at least one control communication channel. For example, the TCP/IP (Transmission Control Protocol/Internet Protocol) stack 44b of the host device 5 receives and processes the unlock request 50 and/or authentication data 61 input by the user, and then forwards the request 50 and/or authentication data 61 to the CDC-NCM driver 32b for further transmission to the DSD 1 over the USB cable 28. The connection established by the USB cable 28 may be enabled by a USB physical layer 47a, 47b under a USB standard (e.g., Universal Serial Bus 4 (USB4)).

The authentication data 61 sent from the host device 5 are further processed by the DSD 1, such as the BE firmware 52 connected to the HTTP server 16 and the TCP/IP stack 44a of the DSD 1. In this example, the DSD complies with the TCG Opal Security standard, and the BE firmware 52 is used for handling authentication, encryption key management, and security enforcement for the Self-Encrypting Drive (SED).

In one embodiment, the BE firmware 52 is used for handling authentication and/or user verification, which ensures password-based authentication via the web server of the DSD 1. In one example where the DSD 1 is an SSD, the SSD remains locked until the correct credentials are provided.

In another embodiment, the BE firmware 52 is used for encryption key management. Specifically, the BE firmware 52 controls access to the encryption key, releasing the encryption key only upon successful authentication to decrypt stored data.

In a further embodiment, the BE firmware 52 is used for managing drive locking and/or security policies, which ensures that the DSD 1 automatically locks on power loss and can only be accessed by authorized users.

In response to verifying the received authentication data 61, for example, the password(s) or hash value matches the corresponding entries stored in the authentication data set 65, at step 270, the at least one processor 7 unlocks the DSD 1. The unlocking step 270 enables access between the host device 5 and the secured partition 8 via a data communication channel 22, as shown in FIGS. 13 and 14. This may include communicatively coupling with the host device 5 via the data communication channel 22, wherein the data communication channel 22 enables communication between the storage medium 19 and the host device 5.

In some examples, enabling access between the host device 5 and the secured partition 8 can include enabling a cryptography engine 23 to encrypt and decrypt user data to be stored and retrieved from the secured partition 8 of the storage medium 19, thereby further protecting integrity and confidentiality of the user data. This is especially relevant in cases where the data storage device 1 is a self-encrypting drive (SED). Enabling a cryptography engine 23 to encrypt and decrypt user data stored in the secured partition 8 may include the cryptography engine 23 encrypting the user data to encrypted data upon receiving the user data from the host device 5. When the authenticated host device 5 requests the user data, the cryptography engine 23 decrypts the encrypted data.

The data communication channel 22 is enabled by a USB mass storage driver 34a, 34b, as illustrated in FIG. 15. Thus, from the host device perspective, the data communication channel 22 provides a connection to a mass storage device. This data communication channel 22 may be configured to transmit and receive user data. The access between the host device 5 and the secured partition 8 typically enables the user of the host device 5 and/or computer programs on the host computer device 5 to access (e.g., read, write and/or modify) the user data stored on the secured partition 8 of the storage medium 19 via the data communication channel 22.

The USB mass storage driver 34a, 34b may include a driver compatible with the USB mass storage device class (e.g. USB MSC, UMS). These are typically drivers that enable a host device to communicate with a USB device that is an external data storage device (such as an external hard drive, NAND flash drive, solid state drives, memory cards, etc).

Such USB mass storage drivers are provided natively to the operating systems of host devices for ease of use and operational efficiency.

In some embodiments, the USB mass storage driver 34a, 34b enables communication through the at least one control communication channel 20 to send and receive data via the first endpoint sets 33a, 33b associated with the mass storage device emulated network adapter 9. The USB mass storage driver 34a, 34b further enables communication through the data communication channel 22 to send and receive data via the second endpoint set 35 associated with the mass storage device 13.

### Specifying IP Address

As discussed earlier, at step 230, the second web application 42 specifies the IP address 43 associated with the DSD 1. The IP address 43 is typically predefined and static, in the form of a unique string of numbers, such as “xxx.xxx.x.x”, uniquely identifying a DSD 1. The predefined IP address 43 may be stored in the second web application 42, for example, as a variable within the JavaScript code for the second web application 42. Alternatively, the predefined IP address 43 may be stored in a second web application data structure associated with the second web application 42. The second web application data structure may be stored in one or more blocks of the secured partition 8 and can take various forms, such as array, stack, list, table, tree or any other data structure that is suitable to store data associated with the second web application 42.

Step 230 further includes the second web application 42 retrieving the predefined IP address 43 corresponding to the webserver 4 of the data storage device from either its internal structure or the second web application data structure stored in the secured partition 8.

In the embodiment as shown in FIG. 15, retrieving the predefined IP address 43 corresponding to the webserver 4 of the DSD 1 comprises: a TCP/IP (Transmission Control Protocol/Internet Protocol) stack 44b of the host device 5 receiving the predefined IP address 43 from the second web application 42. This enables the host device 5 to establish a communication session with the webserver 4 of the DSD 1 over the network.

In some embodiments, the predefined IP address 43 is not available, the second web application 42 assigns a temporary IP address to the DSD 1 to establish a temporary connection between the host device 5 and DSD 1 via the at least one control communication channel 20. The dynamically assigned IP address increases flexibility in scenarios where the static IP is not available. This process may involve generating the temporary IP address based on a predefined algorithm, a random address generator, or a network-assigned address pool, ensuring compliance with network protocols.

Using the above approaches, the user can unlock the drive simply by opening the second web application 42, eliminating the need to manually enter an IP address. This streamlined process enhances user convenience by automatically establishing communication between the host device 5 and the DSD 1. By removing the requirement for manual IP address entry, the system eliminates the need for the user to pre-acquire information about the IP address associated with the DSD 1 (e.g., through a manual or guide), further minimizing potential errors and ensuring a more efficient unlocking experience, even for users with limited technical expertise.

### Communication Channels

In the embodiments where the communication interface 3 includes a USB bridge 31, the at least one control communication channel 20 and the data communication channel 22 are respective logical pipes. Data from the at least one control communication channel and data communication channel may pass through a common physical cable set 28 (such as a USB cable) between the host device 5 and the data storage device 1.

In some embodiments, the DSD 1 is configured to have a first endpoint sets 33a, 33b to send and receive data transferred through the at least one control communication channel 20 to the network adapter 9. The data sent through the at least one control communication channel 20 can include security commands (e.g., by the second web application 42), or setup/configuration commands (e.g., by the first web application 40), to the DSD 1.

In some embodiments, at step 220, the first web application 40 is configured to configure 220 the DSD 1 via the at least one control communication channel 20. In some examples, as shown in FIGS. 13 and 14, the first web application 40 is configured to configure 220 the DSD 1 via a first control communication channel 25 of the at least one control communication channel 20. The DSD 1 is configured to receive 240 the authentication data 61 to unlock 270 the DSD 1 from the host device 5 via a second control communication channel 27 of the at least one control communication channel 20.

In one embodiment, the first control communication channel 25 is the same as the second control communication channel 27. That is, the first web application 40 initially configures the DSD 1 via the control communication channel 20. At a later time, the DSD 1 receives the unlock request 50 and/or the authentication data 61 via the same control communication channel 20. This approach leverages a unified communication channel for both the initial configuration and subsequent unlocking processes, minimizing the complexity of the communication pathways.

In another embodiment, the first control communication channel 25 is different from the second control communication channel 27. In this configuration, the first control communication channel 25 is used by the first web application 40 to configure the DSD 1, while the second control communication channel 27 is dedicated to the unlock process, such as the transmission of the unlock request 50 and/or authentication data 61 to the DSD 1. This separation of control communication channels allows for specialized and independent handling of configuration and unlock processes, which can enhance the security of the configuration process of the DSD 1 and facilitate efficient parallel operations.

### First Web Application and Second Web Application

Typically, the first web application 40 and/or the second web application 42 comprise at least one or more of: Hypertext Markup Language (HTML) (e.g., the “Unlock_Drive.html” in FIGS. 6, 7 and 15), Cascading Style Sheets (CSS) for styling and layout, and JavaScript, etc. In other examples, the web applications include server-side scripts (e.g. PHP (Hypertext Preprocessor) or ASP (Active Server Page)). In some examples, Flask (a Python-based web framework) is used to build the server-side web applications. Collectively implementing scripts using one or more programming languages can provide a user-friendly interface to support required functionalities such as configuring and unlocking the DSD 1.

FIGS. 6 and 7 show an example of the second web application 42. FIG. 7 shows the first interface presented by the browser 12 during the unlocking process. The first interface enables the user to input the authentication data 61. In one example, as shown in FIG. 7, the first interface presents a representation of a prompt 71 to enable a user to enter authentication data 61, such as a password. This prompt may take the form of an input field with clear instructions for the user (e.g., “Enter Your Password:” as shown in FIG. 7).

In some embodiments, the first interface may also include an additional field for entering a username (not shown), which can be useful where the DSD 1 is enabled for multiple users. Additionally, the first interface may include security enhancements, such as masking password input fields or enabling two-factor authentication by requiring a secondary verification code.

In one embodiment, in response to the at least one processor 7 verifying 260 that the received authentication data 61 corresponds to the record in an authentication data set 65, the user interface may further present a notification 72 that informs that user that the DSD 1 is unlocked (e.g., “Your device is successfully unlocked!”), confirming that the access to the DSD 1 is granted.

In some embodiments, the user interface further provides one or more buttons 79, 81 for removal and/or reset of the authentication data 61. In response to the user clicking one of these buttons 79, 81, the first web application 40 is initiated to re-configure the authentication data 61. Re-configuring the authentication data 61, such as the process shown in FIG. 10(a) and 10(b), typically requires the user to demonstrate high-level privileges to ensure that only authorized users can modify or reset the authentication data 61. This process may involve further verification of user credentials and/or device-specific data by the first web application 40, further preventing unauthorized changes to critical authentication settings.

The web application 40 can provide functionalities such as creating, modifying, or deleting logical partitions of the secured partition 8 of the DSD 1, and/or updating firmware of the data storage device 1. The browser 12 of the host device 5 may connect to the webserver 4 through one or more secure protocol, such as HTTPS, ensuring encrypted communication during configuration operations.

In some embodiments, the first web application 40 configuring 220 the DSD 1 comprises sending the first web application 40 from the protected partition 6 to the host device 5 via the first control communication channel 25. The host device 5 then instantiates the first web application 40 on the browser 12 of the host device 5, providing a user-friendly interface to configure the DSD 1.

The first web application 40 configuring 220 the DSD 1 may further comprise configuring data related to access control. This may include storing the authentication data set 65 in the protected partition 6, defining lock/unlock mechanism of the DSD 1, defining access control policies for the secured partition 8, enabling or disabling security features, and/or generating audit logs for data access events.

In some embodiments, configuring 220 the data storage device 1 further comprises encrypting the data related to access control as discussed above. For example, the cryptography engine 22 may encrypt at least part of the authentication data set 65 in the protected partition 6. This encryption process further ensures that sensitive access control information is securely stored, preventing unauthorized access or modification of the data related to access control.

In some embodiments, configuring 220 the data storage device 1 also comprises initializing the second web application 42. Initializing the second web application 42 may include configuring any one or more of the following: i) the first interface (e.g., as exemplified in FIG. 7; ii) a second interface of the second web application 42 to receive the unlock request 50 from the host device 5, and/or iii) a third interface of the second web application (42) to present whether the data storage device 1 is unlocked or not (e.g., as illustrated in FIG. 9(b)). These configurations ensure that the second web application 42 is properly prepared to handle communication with the host device 5 to unlock the DSD 1.

In some embodiments, initializing the second web application 42 also comprises linking an authentication module of the at least one processor of the DSD 1 to the second web application 42. The linking operation may involve establishing a secure communication interface, such as an API (Application Programming Interface) or direct data exchange mechanism, between the second web application 42 and the authentication module to facilitate the verification step 260. In some examples, the authentication module may perform a comparison operation (e.g., a digit-wise comparison) on the authentication data 61 received from the second web application 42 to one or more entries in the authentication dataset 65 stored in the protected partition 6.

Initializing the second web application 42 may further comprise enabling encryption to the unlock request and/or the authentication data 61. This encryption ensures that sensitive information is securely transmitted between the host device 5 and the DSD 1, preventing interception of sensitive authentication data by a third party during the unlock process. For example, the encryption may utilize Advanced Encryption Standard (AES) with a 256-bit key or RSA public-key encryption to secure the data during transmission.

Data in relation to the configuration process 220 may be stored in the protected partition 6, which ensures that important settings are kept secured from accidental changes or unauthorized access. In one embodiment, at least one record of the configuration data related to access control is stored in the protected partition 6 via the first web application 40.

### Advantages

The present disclosure includes using a first web application and a second web application configured to configure the data storage device (DSD) and unlock the DSD, respectively. Separating the configuration functionality from the unlocking functionality allows for a lightweight second web application designed specifically for unlocking the DSD. The second web application can be seamlessly implemented once the USB connection between the DSD and the host device is established, requiring negligible resources. This enables a streamlined and efficient unlocking process.

The first web application provides a user-friendly and secured way to configure the DSD. By offering an intuitive interface, the first web application simplifies the configuration process, allowing users to set up access control policies, manage authentication data, and enable or disable security features with ease. Using a protected partition of the storage medium to provide the first web application ensures that sensitive configuration operations and associated configuration data are protected from unauthorized access and/or modification.

Notably, the first and second web applications can operate directly within any web browser installed on the host device, eliminating the need for additional software installation and ensuring compatibility across different operating systems of the host device. This approach enhances accessibility, simplifies the configuration and unlocking process, and ensures broad usability across a variety of environments.

Examples of the presently described data storage device 1 and method 100 enable the unlock process of the data storage device 1 without requiring an internet connection. This capability is particularly advantageous is in temporary or remote environments where internet access is unavailable or unreliable, such as in field operations, offsite locations, or secure facilities with restricted network access. This allows users to access their data regardless of connectivity. By eliminating the dependency on an internet connection, the system ensures that users can access their data seamlessly and securely, regardless of connectivity, thereby enhancing the portability, reliability, and user convenience of the data storage device.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A data storage device, comprising:
a storage medium comprising:
a protected partition inaccessible through a mass storage device protocol, wherein the protected partition stores program code, when executed, to emulate at least a webserver configured to provide a first web application to a browser of a host device to configure the data storage device;
a secured partition configured to store user data under the mass storage device protocol, and
an unsecured partition readable by the host device, wherein the unsecured partition stores at least a second web application, wherein the second web application is different from the first web application and is executable through the browser of the host device to unlock the data storage device;
a communication interface configured to communicate with the host device; and
at least one processor configured, individually or in combination, to:
communicatively couple with the host device, via at least one control communication channel, wherein the at least one processor is configured to emulate a network adapter to the host device, wherein the at least one control communication channel is enabled by an Ethernet over USB (Universal Serial Bus) protocol driver, wherein the second web application is configured to specify an IP (Internet Protocol) address associated with the data storage device to unlock the data storage device via the at least one control communication channel;
receive, via the at least one control communication channel, authentication data to unlock the data storage device, wherein the authentication data is received from the second web application instantiated at the browser of the host device;
verify that the received authentication data corresponds to a record in an authentication data set configured by the first web application; and
in response to verifying the received authentication data, unlock the data storage device to enable access between the host device and the secured partition via a data communication channel, wherein the data communication channel is enabled by a USB mass storage driver.

2. The data storage device according to claim 1, wherein specifying the IP address associated with the data storage device by the second web application comprises:
retrieving, by the second web application, a predefined IP address corresponding to the webserver of the data storage device,
wherein the predefined IP address is stored in the second web application or stored in a second web application data structure associated with the second web application,
wherein the second web application data structure is stored in the secured partition.

3. The data storage device according to claim 2, wherein retrieving the predefined IP address corresponding to the webserver of the data storage device comprises: receiving, by a TCP/IP (Transmission Control Protocol/Internet Protocol) stack of the host device, the predefined IP address from the second web application.

4. The data storage device according to claim 1, wherein the first web application is configured to configure the data storage device via the at least one control communication channel.

5. The data storage device according to claim 4, wherein the first web application is configured to configure the data storage device via a first control communication channel of the at least one control communication channel, and wherein the data storage device is configured to receive the authentication data to unlock the data storage device via a second control communication channel of the at least one control communication channel.

6. The data storage device according to claim 5, wherein the first control communication channel is different from the second control communication channel.

7. The data storage device according to claim 5, wherein the first control communication channel is the same as the second control communication channel.

8. The data storage device according to claim 1, wherein the at least one processor is further configured to receive, via the at least one control communication channel, an unlock request from the host device using the second web application, wherein in response to receiving the unlock request, the second web application initiates a first interface in the browser of the host device, wherein the first interface is configured to receive the authentication data to unlock the data storage device.

9. The data storage device according to claim 8, wherein the second web application is configured to automatically initiate the first interface in the browser of the host device in response to the at least one control communication channel being established.

10. The data storage device according to claim 8, wherein the Ethernet over USB protocol driver is a CDC-NCM (Communication Device Class Network Control Model) driver, wherein the unlock request from the host device and the authentication data are received from the CDC-NCM driver over the at least one control communication channel.

11. The data storage device according to claim 1, wherein the first web application configuring the data storage device comprises any one or more of:
sending the first web application from the protected partition to the host device, wherein the host device instantiates the first web application on the browser of the host device;
configuring data related to access control including storing the authentication data set in the protected partition;
encrypting the data related to access control; and/or initializing the second web application including any one or more of:
configuring any one or more of: the first interface, a second interface of the second web application configured to receive the unlock request from the host device, and/or a third interface of the second web application configured to present whether the data storage device is unlocked or not;
linking an authentication module of the at least one processor of the data storage device to the second web application; and/or
enabling encryption to the unlock request and/or the authentication data.

12. The data storage device according to claim 1, wherein the second web application stored in the secured partition is read-only and/or write protected.

13. The data storage device according to claim 1, wherein the communication interface includes a USB bridge, and wherein the at least one control communication channel and the data communication channel are respective logical pipes through a USB interface between the host device and the data storage device.

14. The data storage device according to claim 1, wherein the first web application and/or the second web application comprise at least one or more of:
Hypertext Markup Language (HTML);
Cascading Style Sheets; and
JavaScript.

15. A method for unlocking a data storage device using a host device, wherein the data storage device comprises a storage medium comprising: a protected partition inaccessible through a mass storage device protocol, wherein the protected partition stores program code that, when executed, emulates at least a webserver configured to provide a first web application to a browser of a host device to configure the data storage device; and a secured partition configured to store user data under the mass storage device protocol, wherein the secured partition stores at least a second web application, wherein the second web application is different from the first web application and is executable through the browser of the host device to unlock the data storage device; wherein the data storage device further comprises a communication interface configured to communicate with a host device and at least one processor; the method comprising:
communicatively coupling with the host device, via at least one control communication channel, wherein the at least one processor is configured to emulate a network adapter to the host device, wherein the at least one control communication channel is enabled by an Ethernet over USB (Universal Serial Bus) protocol driver, wherein the second web application is configured to specify an IP (Internet Protocol) address associated with the data storage device for unlocking the data storage device via the at least one control communication channel;
receiving, via the at least one control communication channel, authentication data to unlock the data storage device, wherein the authentication data is received from the second web application instantiated at the browser of the host device;
verifying that the received authentication data corresponds to a record in an authentication data set configured by the first web application; and
in response to verifying the received authentication data, unlocking the data storage device to enable access between the host device and the secured partition via a data communication channel, wherein the data communication channel is enabled by a USB mass storage driver.

16. The method according to claim 15, wherein specifying the IP address associated with the data storage device by the second web application comprises retrieving a predefined IP address corresponding to the webserver of the data storage device, wherein the predefined IP address is stored in the second web application.

17. The method according to claim 16, wherein retrieving the predefined IP address corresponding to the webserver of the data storage device comprises receiving, by a TCP/IP (Transmission Control Protocol/Internet Protocol) stack of the host device, the predefined IP address from the second web application.

18. The method according to claim 13, wherein the first web application is configured to configure the data storage device via a first control communication channel of the at least one control communication channel, wherein the data storage device is configured to receive the authentication data to unlock the data storage device via a second control communication channel of the at least one control communication channel, and wherein the first control communication channel is different from the second control communication channel.

19. The method according to claim 13, further comprising configuring the data storage device, the method further comprising:
sending the first web application from the protected partition to the host device, wherein the host device instantiates the first web application on the browser of the host device;
receiving, from the host device, configuration data related to access control, including data related to the authentication data set;
storing, via the first web application, at least one record of the configuration data related to access control in the protected partition;
encrypting the data related to access control; and/or initializing the second web application including any one or more of:
generating any one or more of: the first interface, a second interface of the second web application configured to receive the unlock request from the host device, and/or a third interface of the second web application to present whether the data storage device is unlocked or not;
linking an authentication module of the at least one processor of the data storage device to the second web application; and/or
enabling encryption to the unlock request and/or the authentication data.

20. A data storage device comprising:
at least one processor;
means for storing data, the data including program code that, when executed, emulates at least a webserver configured to provide a first web application to a browser of a host device to configure the data storage device, a second web application, wherein the second web application is different from the first web application and is executable the browser of the host device to unlock the data storage device;
means for communicatively coupling with the host device, via at least one control communication channel, wherein the at least one processor is configured to emulate a network adapter to the host device, wherein the at least one control communication channel is enabled by an Ethernet over USB (Universal Serial Bus) protocol driver, wherein the second web application is configured to specify an IP (Internet Protocol) address associated with the data storage device to unlock the data storage device via the at least one control communication channel,
means for receiving, via the at least one control communication channel, authentication data to unlock the data storage device, wherein the authentication data is received from the second web application instantiated at the browser of the host device;
means for verifying that the received authentication data corresponds to a record in an authentication data set configured by the first web application; and
means for unlocking the data storage device to enable access between the host device and the secured partition via a data communication channel, wherein the data communication channel is enabled by a USB mass storage driver.
